(19) United States
(12) Patent Application Publication
(10) Pub. No.: US 2010/0301298 A1
(43) Pub. Date: Dec. 2, 2010

(54) BARRIER

(75) Inventor: Daniel Mawby, Victoria (AU)

Correspondence Address: BROOKS KUSHMAN P.C., 1000 TOWN CENTER, TWENTY-SECOND FLOOR, SOUTHFIELD, MI, 48075, US

(73) Assignee: MAWSAFE PRODUCTS PROPRIETARY LIMITED, Woodend, Victoria (AU)

(21) Appl. No.: 12/745,630

(22) PCT Filed: Dec. 1, 2008
(86) PCT No.: PCT/IB08/03282

§ 371 Date: Jun. 1, 2010

(30) Foreign Application Priority Data
Nov. 30, 2007 (AU) 2007906546
Jun. 16, 2008 (AU) 2008903011
Jun. 16, 2008 (AU) 2008903062
Oct. 30, 2008 (AU) 2008905604

(51) Int. Cl. E04H 17/20; B23P 11/00

(52) U.S. Cl. 256/65.03; 29/428; 29/426.5

(57) ABSTRACT

There are provided improved versions of a barrier fence 218 suitable for racetracks. The fence comprises an elongate rail 219 and uprights 220 secured thereto at positions along the rail, wherein an upright is secured at an upper end to the rail and at a lower end to a ground anchor 201. The lower end of the upright is adapted to separate from its associated ground anchor in response to an impact load on the upright. The improvements include improvements to connection of the uprights to the ground anchors, avoiding undesirable motion of uprights after impacts, rail length joining arrangements, erection and handling methods, and the provision of permanent footings.

### TECHNICAL FIELD

This invention concerns a barrier fence for use in bounding horse racing tracks and other similar applications. The barrier is readily assembled and able to absorb impacts in a safe and predictable manner.

### BACKGROUND ART

In the sport of horse racing, elongate fences are provided to act as boundaries of the actual courses on which the horses race. It is desirable that such fences be able to be installed and relocated reasonably easily, and most importantly that they present the smallest possible hazard to horses and jockeys in the event of one or more of them falling. Barrier fences have been developed for horse- and other racing applications but have not always performed well in these respects.

In international patent application No. PCT/AU2007/001343 filed on 12 Sep. 2007 by Mawby, hereinafter referred to as the Mawby application, there are disclosed certain barrier fences that are believed reasonably easy to install, to remove, to relocate and to repair, and that can be designed to restrict the potential for harm to horses and jockeys in the event of a fall or other accident. The as-filed specification of that application (published on 20 Mar. 2008 under the number WO 2008/031150 A1) is explicitly made a part of the present specification, in its entirety, by reference.

There are disclosed herein improvements to the barrier fences disclosed by Mawby, and additional methods for their deployment and handling.

### DISCLOSURE OF INVENTION

Barrier fences according to the invention, as described herein, are intended to be suitable for example for use on a horse racing track and for convenience will be described below in that context. However, it is to be understood that they and the methods and principles involved in their construction are potentially applicable to other applications also, for example to barrier fences for other forms of animal racing courses and even for barriers that guide or restrain people in public places.

FIG. 1 shows how barrier fences according to the invention are intended to behave. FIG. 1 shows two aerial perspective views of a portion of a barrier fence 3001, with much detail omitted. Barrier fence 3001 comprises a continuous rail assembly 3002 supported by uprights 3003a, 3003b, 3003c, 3003d, 3003e whose lower ends are secured to the ground by ground anchors 3005. At (a), barrier fence 3001 is shown under no external load. At (b), barrier fence 3001 is shown under a load (represented by arrow 3555) applied laterally to rail assembly 3002, and can be seen to have deflected partly by bending of rail assembly 3002 and partly by bending of the uprights 3003b, 3003c, 3003d. Load 3555 could be for example due to barrier fence 3001 being nudged by one or more horses (not shown) racing on the left side of the rail assembly 3002 as shown in FIG. 1. Up to a certain level of force 3555 it is required that its removal simply cause the barrier fence 3001 to return resiliently back to the condition shown at (a).

In FIG. 1(a) the ground anchors 3005 are shown to be offset rearwardly from the rail assembly 3002. This is to avoid interference with horses' legs and hooves in the event that they race close to rail assembly 3002 or nudge and deflect rail assembly 3002. It is further desired of barrier fence 3001 that at the maximum intended value of forces such as force 3555, the ground anchors 5 remain offset rearwardly of rail assembly 3002.

However, beyond the maximum level of force 3555, for example in the case of one or more horses falling or pushing excessively hard on rail assembly 3002, it is required that one or more of uprights 3003 would separate at or near their lower ends from their ground anchors 3005. Separation at or near lower ends of uprights 3003 is desirable to avoid injuries to horses and jockeys from, for example, broken uprights 3003 extending up from ground level. It is further required that if such separation of uprights 3003 occurs, the uprights 3003 behave predictably and do not become a further hazard to horses and riders.

It is further desired that barrier fence 3001 respond in a predictable and safe manner to impacts directly on uprights 3003, for example by unseated riders. Specifically, uprights 3003 should again break way at or near their lower ends, and thereafter behave in a safe and predictable manner. To minimize injuries, such breaking away needs to occur at impact loads generally lower than the maximum lateral load 3555 on rail assembly. However, the ability to break away under comparatively low impact loads applied to the uprights 3003 must be achieved while allowing forces 3555 applied to rail 3002 to be substantial.

Finally, if a rider falls on an upright 3003 from above, it is desirable that his or her impact lead to as little personal harm as possible.

Accordingly, barrier fences according to the present invention are intended to address at least some of these problems.

Relative to what is disclosed in the Mawby application, the following inventive further embodiments, optional features and erection methods, are disclosed herein:
(aa) A barrier fence that is generally similar to fence 218, but whose bottom fitting (equivalent to fitting 205) is not snap-fittingly engaged in the ground anchor (equivalent to ground anchor 201).
(bb) Provision to ensure that where the bottom fitting of an upright (such as upright 220) parts company from its ground anchor under impact, the risk of the upright separating from the rail assembly to which it is attached is reduced for certain types of upright top end fitting, in particular fittings such as fitting 710. Provision also to ensure that where the bottom fitting of an upright parts company from its ground anchor under impact, the risk of the upright causing injury through excessively rapid rotation is reduced.
(cc) Further methods for joining rail extrusions.
(dd) Methods for erecting and dismantling barrier fences.
(ee) Provisions to ensure that where the bottom fitting of an upright parts company from its ground anchor under impact, the upper end of the upright can rotate not only about an axis extending transverse to the rail assembly, but about another axis, so as to further reduce the potential for injury.
(ff) Provision for one or more “preferred” barrier fence positions where erection of a barrier fence is quicker, easier and less likely to damage to ground surfaces than erection in other positions.
(gg) An additional arrangement for connection of upright tubes to their bottom end fittings to enable rotation during fence assembly.

Accordingly, the invention provides a barrier fence comprising an elongate rail and uprights secured thereto at positions along the rail, wherein an upright is secured at an upper end to the rail and at a lower end to a ground anchor.

The lower end of the upright is preferably adapted to separate from its associated ground anchor in response to an impact load on the upright and characterized in at least one of the followings ways:
(a) prevention of separation of the upright from the ground anchor is achieved substantially by means of contact pressure between a lower end fitting comprised in the upright and formations comprised in the ground anchor as opposed to mechanical confinement of the lower end fitting by the ground anchor when the lower end fitting is secured to the ground anchor;
(b) a lower end fitting comprised in the upright is non-snap-fittingly secured to the ground anchor;
(c) a lower end fitting comprised in the upright is in use located on the ground anchor by a frangible means connecting the lower end fitting and the ground anchor the frangible means preferably comprising a shear pin and said frangible means contributing only a minority of resistance to separation of the lower end fitting from the ground anchor;
(d) an upper end fitting comprised in the upright is held captively secured to the rail for a defined range of relative positions of the upper end fitting only and the upper end fitting is provided with removable means for preventing separation of the upper end fitting and the rail when the upper end fitting is outside the defined range;
(e) the rail and an upper end fitting comprised in the upright are so configured as to provide a detent against and/or frictional resistance to relative movement of the upper end fitting and the rail in at least one relative position of the upper end fitting and the rail in which the upright is separated from the ground anchor;
(f) an upper end fitting comprised in the upright is adapted to permit rotation of the upright about multiple axes after separation of a lower end fitting comprised in the upright from the ground anchor;
(g) the ground anchor has a portion that is adapted to be either driven into a ground surface or received in a shaped opening in a ground surface and held against rotation about an upright axis when in said shaped opening;
(h) firstly, the upright comprises a tube and a lower end fitting that is received and rotatable in a lower end of the tube and secondly one of the lower end fitting and the tube is provided with a slot extending partway peripherally around that one and thirdly to the other of the lower end fitting and the tube there is secured an elongate means (preferably a screw) receivable in the slot so as to secure the lower end fitting to the tube and so as to permit relative rotation of the tube and the lower end about a mutual longitudinal axis within a range defined by the length of the slot;
(i) the rail comprises a plurality of rail lengths joined end to end and comprises at a joint between two such rail lengths a sleeve that extends at least partway around an external surface of one of the lengths and that comprises one or more formations that are received in internal spaces of the other of the lengths; and
(j) the rail comprises a plurality of rail lengths joined end to end and comprises at a joint between two such rail lengths two elongate bolt members each one slidingly received in an internal space of one of the rail lengths, the bolt members having formations that cooperate with each other so as to prevent longitudinal relative movement of the bolt members

Additional aspects of the invention are set out in the appended claims, which are made part of this disclosure of the invention.

Additional features and aspects of the invention, newly disclosed in this specification, will be found in the following detailed description.

Note that throughout this specification, the word “comprise” and words derived therefrom such as “comprising” and “comprised”, when used in relation to a set of integers elements or steps are to be taken as indicating that the elements integers or steps are present but not to be taken as precluding the possible presence of other elements integers or steps.

### BRIEF DESCRIPTION OF DRAWINGS

FIG. 1 shows at (a) a perspective view of a barrier fence according to the invention with much detail omitted, and under no load, and at (b) the same view of that barrier now under a load applied laterally to a rail assembly;

FIG. 2 is a perspective view of a portion of a barrier fence according to the invention.

FIG. 3 is a cross-sectional view of the barrier shown in FIG. 2 the section being taken at station “AA”;

FIG. 4 is a cross sectional view of the barrier shown in FIG. 3, the cross section being taken at station “BB” and certain parts not being shown in section;

FIG. 5 is a perspective exploded view showing a lower portion of an upright of the barrier of FIG. 2 and a ground anchor of that barrier;

FIG. 6 is an elevation of the ground anchor shown in FIG. 5;

FIG. 7 is a cross-sectional view of the ground anchor of FIG. 6 the section being taken at Station “CC”, and assembled thereto and shown in cross-section a lower portion of an upright of the barrier;

FIG. 8 is an elevation of a ground anchor for an alternative embodiment of a barrier according to the invention, and a lower portion of an upright thereof;

FIG. 9 is an elevation of a connecting piece for use with the ground anchor shown in FIG. 8, the connecting piece being shown partly sectioned;

FIG. 10 is an elevation of an alternative connecting piece for use with the ground anchor shown in FIG. 8, the alternative connecting piece being shown partly sectioned;

FIG. 11 is an elevation of a second alternative connecting piece for use with the ground anchor shown in FIG. 8;

FIG. 12 is a cross-sectional view of the second alternative connecting piece shown in FIG. 11, the section being taken at Station “DD”;

FIG. 13 is a perspective view of an assembly including rail connector for use in a further barrier according to the invention, with end portions of two rail lengths being shown in chain-dotted lines;

FIG. 14 is a cross-sectional view of the assembly of FIG. 13;

FIG. 15 is a cross-sectional view of a further rail assembly for a further barrier according to the invention, the section being taken at a connection point;

FIG. 16 is an elevation of an alternative embodiment for the upper portion of an upright for another barrier according to the invention, with a section of rail shown in cross-section;

FIG. 17 is a cross-sectional view of the arrangement shown in FIG. 16, the section being taken at station “EE”;

FIG. 18 is a cross-sectional view the same as FIG. 17, save for substitution of a modified version of one part;

FIG. 19 is a cross-sectional view the same as FIG. 17, save for substitution of a second modified version of one part;

FIG. 20 is a perspective view of a connection in a rail assembly of the barrier shown in FIG. 2;

FIG. 21 is a transverse cross-sectional view of the rail assembly shown in FIG. 20, the section being taken at station “FF”;

FIG. 22 is a transverse cross-sectional view of a rail assembly that is an alternative to that of FIG. 21, the section being equivalent in viewpoint to that of FIG. 21;

FIG. 23 is a transverse cross-section of a further rail assembly according to the invention, the section being taken at a point of attachment of an upright and the upright itself not being sectioned);

FIG. 24 is a cross-sectional view of an upper portion of the upright shown in FIG. 23, the cross-section being taken at Station “GG”;

FIG. 25 is a side elevation of an alternative ground anchoring arrangement according to the invention;

FIG. 26 is a cross-sectional view taken at station “26-26” in FIG. 25;

FIG. 27 is a cross-sectional view taken at station “27-27” in FIG. 25;

FIG. 28 is a plan view of a fence portion using the arrangement shown in FIG. 25;

FIG. 29 is an end view of the fence portion shown in FIG. 28, looking in the direction of arrow “Z”;

FIG. 30 is a side elevation of a further alternative ground anchoring arrangement according to the invention;

FIG. 31 is a plan view of an alternative upright upper end fitting according to the invention;

FIG. 32 is a side elevation of the fitting shown in FIG. 31;

FIG. 33 is a side elevation of an upright upper end fitting as shown in FIG. 29;

FIG. 34 is a perspective view of a portion of the barrier fence shown in FIG. 29;

FIG. 35 is a perspective view of an alternative to a specified part shown in FIG. 34;

FIG. 36 is a sectional view taken transverse to a rail assembly of an upright upper end configuration in a further embodiment of the invention;

FIG. 37 is a side elevation of a yet further arrangement for an upright lower end according to the invention;

FIG. 38 is a cross-sectional view taken at station “38-38” in FIG. 25;

FIG. 39 is a cross-sectional view taken at station “39-39” in FIG. 37;

FIG. 40 is an elevation of a yet further fitting for connecting an upright to a barrier railing with the barrier railing cross-sectional shape being shown only in outline;

FIG. 41 is a view of a portion of the fitting shown in FIG. 40 as seen looking in the direction of arrow “PQ”, and with the barrier railing now omitted;

FIG. 42 is a plan view from above of a portion of the fitting shown in FIG. 41;

FIG. 43 is a view looking along the length of a further barrier fence according to the invention;

FIG. 44 is at (b) a side view of an upright upper end fitting of an upright of the fence shown in FIG. 43, and at (a) a view of the same fitting shown looking in the direction of arrow “44a”;

FIG. 45 is a perspective view of a ground anchor of the fence shown in FIG. 43;

FIG. 46 is a cross-sectional partial view of the ground anchor shown in FIG. 45, the section being taken at station “46-46”;

FIG. 47 is a perspective view of a portion of the fence shown at FIG. 43, being driven into the ground;

FIG. 48 is a perspective view of a fitting usable on a hammer for carrying out the driving shown in FIG. 47;

FIG. 49 is a side elevation of a ground anchor of the fence shown in FIG. 43 being withdrawn from the ground;

FIG. 50 is a perspective exploded view of a joint between two lengths of rail of a barrier fence rail assembly;

FIG. 51 is a cross-sectional view of a the joint between two rail lengths shown in exploded form in FIG. 50, the section being taken in a plane containing the line “51-51” and extending in the lengthwise direction of the rail lengths when joined;

FIG. 52 is a perspective view from below of a ground anchor of the barrier fence shown in FIG. 29;

FIG. 53 is a perspective view of a ground surface provided with footings;

FIG. 54 is a cross-section through a footing as shown in FIG. 53, the section being taken at station “54-54”;

FIG. 55 is a perspective exploded view of a lower end of an upright usable in the fence shown in FIG. 29;

FIG. 56 is a cross section through the upright lower end shown in FIG. 55, now assembled, the section being taken at station “56-56”;

FIG. 57 is a cross section through the upright lower end shown in FIG. 56, the section being taken at station “57-57”.

### MODES FOR CARRYING OUT THE INVENTION

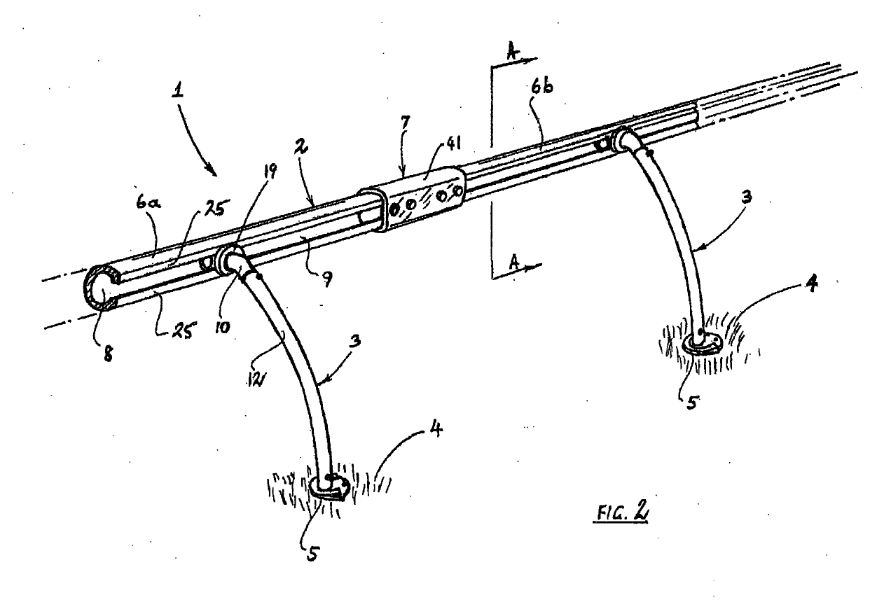

FIG. 2 shows a portion of a first barrier fence 1 according to the invention. Barrier fence 1 comprises a rail assembly 2 supported at spaced apart locations along its length by uprights 3 that are anchored to the ground 4 by anchors 5. Although only two uprights 3 are shown in FIG. 2, and a short length of the rail assembly 2, it is to be understood that barrier fence 1 can be made in any required length by providing a longer rail assembly 2 and more uprights 3 and ground anchors 5 than are shown.

In FIG. 2, barrier fence 1 is shown as seen by an observer positioned on the side of barrier fence 1 opposite that on which horses would pass, the uprights 3 being placed so as not to interfere with the horses' progress. For convenience, the side of the barrier fence 1 on which horses pass will be referred to herein as the “front” side of the barrier fence 1 and the opposite side will be described as the “rear” side of the barrier fence 1. The same convention will be used in respect of rail assembly 2 and its constituent parts.

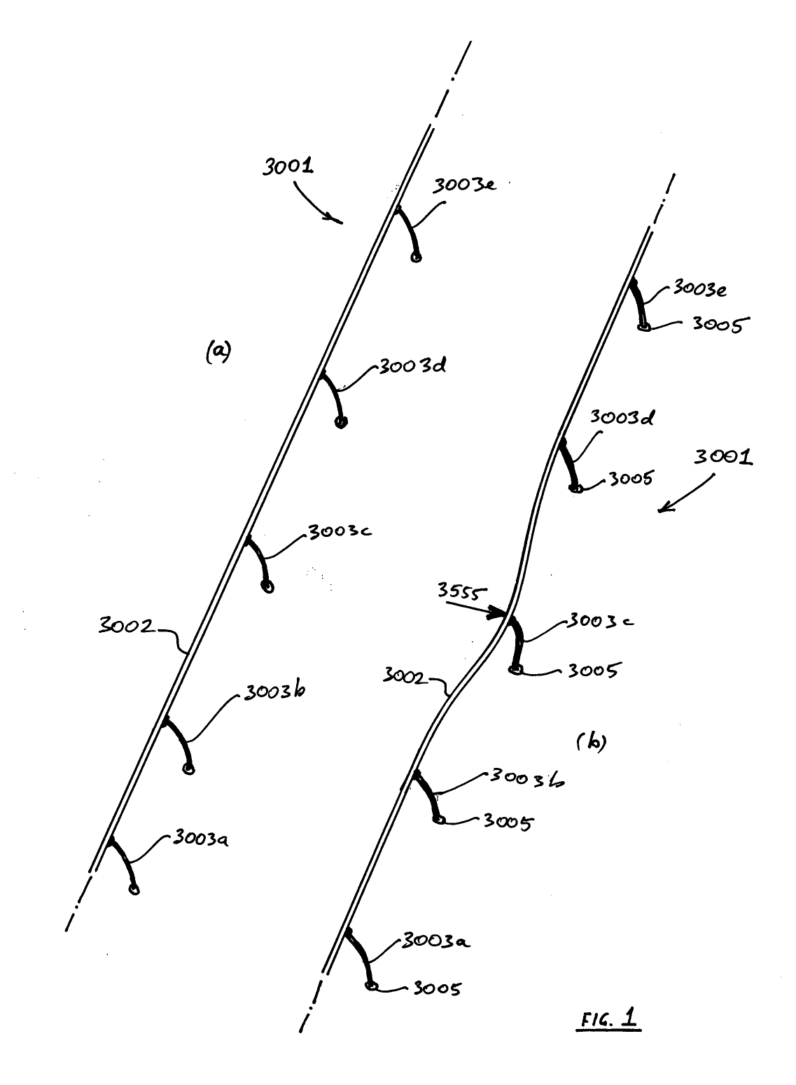

Based on this convention, forces such as force 3555 in FIG. 1 are herein described as rearwardly directed, and the deflection of barrier fence 1 as shown in FIG. 1(b) is described as rearward deflection.

Rail assembly 1 comprises firstly a number of rail sections 6 (of which parts of two only, 6a and 6b, are shown in FIG. 2) arranged end-to-end and secondly connection assemblies 7 that connect adjoining ends of the rail sections 6. Thus rail assembly 2 is a continuous elongate structure.

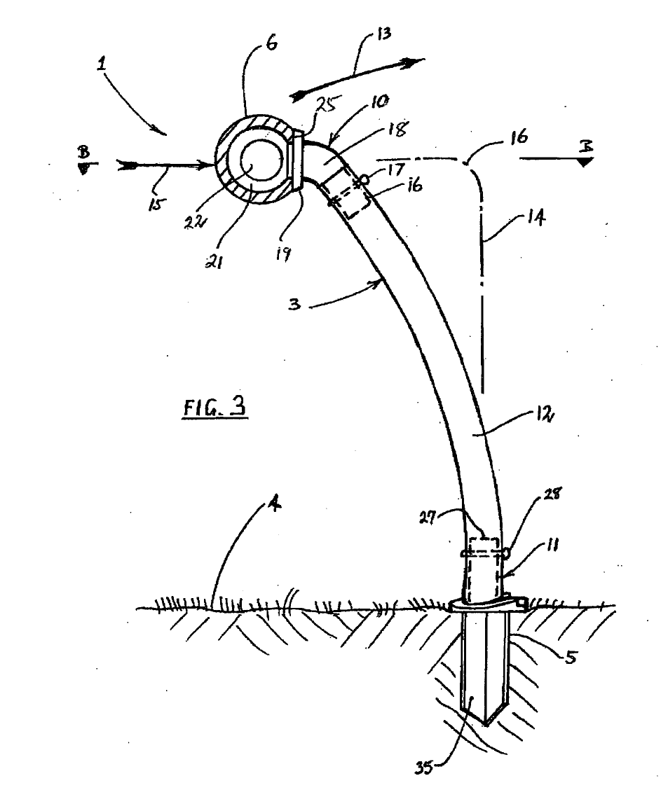

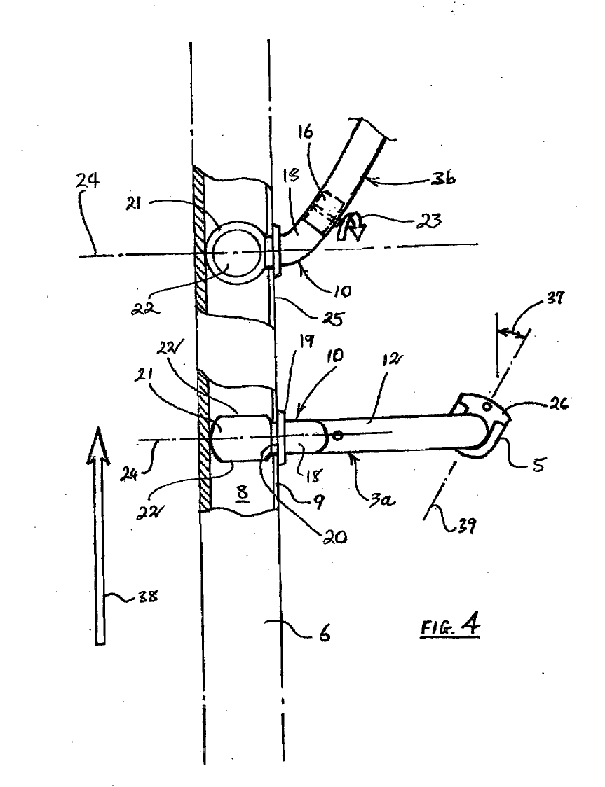

Each rail section 6 is preferably of constant cross-sectional shape along its length, and has, extending lengthwise, an internal space 8 that opens to the rear side of the rail section through a lengthwise slot 9. See also FIGS. 3, 4. Although a C-section shape is shown for rail sections 6, and has the advantages of low wind resistance and of being potentially less harmful to a horse impacting it than many other possible sections, any suitable external shape may be used.

Rail sections 6 may be formed by extrusion in a suitable plastics material or by rolling or extrusion in a suitable metallic material, but this is not to preclude the possible use of any other suitable materials or fabrication methods consistent with the objectives set out above.

It is intended that the rail assembly 2 be sufficiently rigid to hold its shape as a part of barrier fence 1, but to the degree found suitable for the application, to have enough flexibility in bending to deflect to a suitable degree when struck, without shattering, and with enough resilience to spring back after a deflecting force is removed. Choosing the material and rail dimensions to achieve these objectives does not of itself require inventive skill.

Each upright 3 comprises a tube 12 with an upper end fitting 10 for attachment of the upright 3 to a rail section 6 and a lower end fitting 11 for attachment of the upright 3 to ground anchor 5. Tube 12 is sufficiently rigid to ensure that uprights 3 support rail assembly 2 adequately, but sufficiently flexible to deflect rearwardly (as shown by arrow 13 in FIG. 3) when impact loads (as represented by arrow 15) are applied to rail assembly 2, without shattering and with enough resilience to spring back to its original shape after the load is removed. Choosing the material and tube dimensions to achieve these objectives does not of itself require inventive skill. Suitable plastics tube may be used, for example.

Tube 12 has an arcuate shape as seen in the view of FIG. 3. This ensures that the lower end fittings 11 and ground anchors 5 are well rearward of rail assembly 2 so as not to interfere with horses passing on the front side of rail assembly 2 while the upper ends of uprights 3 are close to the rear of rail assembly 2 to minimize hazards to jockeys who may fall over the rail assembly 2. The arcuate shape and this offsetting of the ground anchors 5 also mean that an inwardly directed transverse load (due for example to an impact from a horse) on the front of rail assembly 2 near upright 3 deflects the upper end of tube 12 both rearwardly and (to a lesser degree) upwardly as shown by arrow 13. This upward movement of the top of tube 12 and nearby parts of rail assembly 2 is believed to progressively increase the tendency for a horse nudging rail assembly 2 to withdraw from the rail assembly 2.

The arcuate shape shown is preferred, but may be varied if required. For example the radius of curvature may be increased somewhat beyond that shown. It may even be made substantially straight. Dotted line 14 in FIG. 3, however, shows a possible alternative shape (i.e. tube centreline shape) for tube 12 that is less preferred. If tube 12 had the shape shown by broken line 14, a lateral load (as shown by arrow 15) on the rail assembly 2 would lead to more concentrated stresses at the lower end of tube 12 and in the corner area 16 with a greater risk of the tube failing there in such a manner as to present an impaling risk to a horse or falling jockey. Further, even if there is no failure of a tube when in the shape shown at 14, a rider falling onto such a tube from above would likely be harmed more than if it had the shape shown in solid lines in FIG. 3, which tends to shed loads dropping on it. Finally, the initial movement of rail assembly 2 under an impact load in the direction of arrow 15 would likely have a smaller upward component than if tube 12 had the shape shown in solid lines in FIG. 3. Generally it is preferred that tube12 extend smoothly between its lower and upper end fittings.

The method by which uprights 3 of barrier fence 1 are secured to the rail assembly 2 will now be described, by reference to FIGS. 2, 3 and 4. FIG. 4 shows a view from above of a rail section 6 and two uprights 3a, 3b of which one 3a is in a working position secured to a ground anchor 5 and the other 3b is in a position where it is being initially secured to rail section 6 before securing to a ground anchor (not shown). Upper end fitting 10 comprises a stub 16 that is close-fittingly received in the upper end of tube 12, with a securing pin 17 extending through tube 12 and stub 16. From stub 16 a transition piece 18 extends to a flange 19. On the opposite side of flange 19 is a neck 20 and secured to neck section 20 is a ball member 21 whose shape is spherical save for two parallel flat surfaces 22 and except where ball member 21 is truncated and secured to neck 20. Flat surfaces 22 are so spaced apart that ball member 21 can be inserted through slot 9 when surfaces 22 are aligned with slot 9 in the way shown by upright 3b in FIG. 4. Then, by rotation of upright 3 as shown by arrow 23 about a horizontal axis 24 with ball member 21 within space 8, upright 3b can be brought to a position where it can be secured to ground anchor 5 like that of upright 3a in FIG. 4. Upright surfaces 25 adjacent to slot 9 on the rear side of rail sections 6 abut flange 19, and ball member 21 closely fits within the internal space 8. Preferably, neck 20 closely fits within slot 9 also. Thus, uprights 3 can rotate about their respective axes 24 if their lower ends are separated from ground anchor 5, but are retained in connection with rail assembly 2 until unless they rotate a full 90 degrees to the position of upright 3b. The upper end fitting 10 helps ease the assembly of barrier fence 1 as uprights 3 can be simply slotted into rail assembly 2 and rotated into position for connection to ground anchors 5.

The method by which uprights 3 are secured to the ground 4 will now be described, by reference particularly to FIGS. 3, 5, 6 and 7. Fitting 11 comprises a tapered, foot-shaped body 26 and an upstanding tubular stub 27 which in use is received close-fittingly in the lower end of tube 12, and secured there by a pin 28. Instead of or in addition to pin 28, adhesive may be used, or simply a close fit to ensure that stub 27 stays fixed in tube 12. Stub 27 has a groove 34 extending around its circumference and partway through the wall 36 of stub 27. Fitting 11 may be a fabricated component or may be integrally formed as a single item, for example by die casting in a suitable metallic material or by injection moulding in a suitable plastics material.

Foot 26 is able to be slid into a space 29 defined by sidewalls 30, a top plate 31 and a baseplate 32 of ground anchor 5, and be secured in that space by a pin 33 passing through holes in both body 26 and baseplate 32. Depending from baseplate 32 of ground anchor 5 is a spike 35 of cruciform cross-section that in use is driven into the ground 4 to the point where the baseplate 32 is close to the surface of ground 4.

When the barrier fence 1 is being erected, a ground anchor 5 is driven into ground 4 and the fitting 11 comprised in an upright 3 is entered into space 29 of ground anchor 5 and secured there by pin 33. Generally upright 3 will first have been secured to rail assembly 2, in the way described above. Referring to FIG. 4, it is to be noted that a non-zero angle 37 is shown between axis of symmetry 39 of foot 26 and the direction of the length of the barrier fence, represented by the arrow 38. It is thought that for the best performance under impacts (see below) this may be advantageous, but a zero value for angle 37 is by no means precluded.

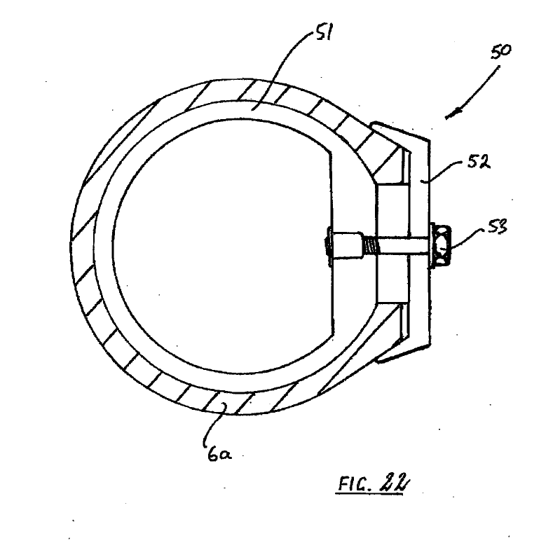

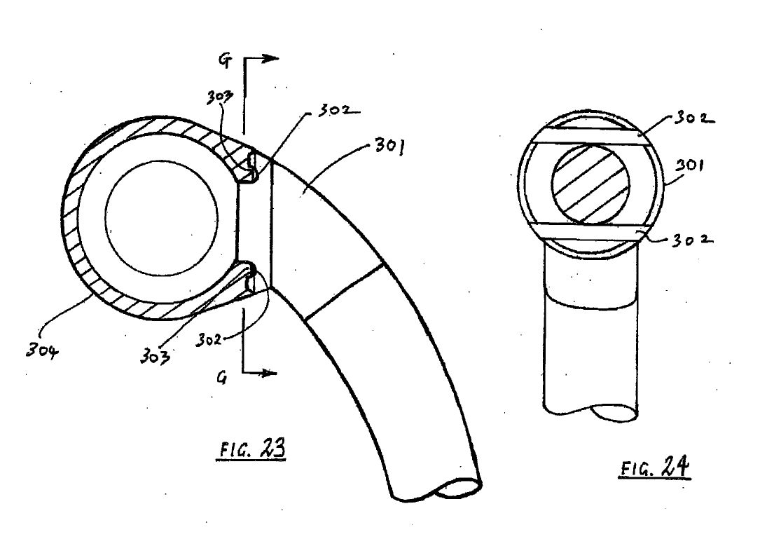

Means by which adjacent pairs of rail sections 6 (for example 6a and 6b) are connected end-to-end by a connector assembly 7 will now be described. Refer to FIGS. 20 and 21. An internal member 40 is shaped to be close-fitting in the space 8 of rail sections 6a and 6b and is entered into the ends of sections 6a and 6b. An outer sleeve 41 is shaped to fit close-fittingly over the exterior of rail sections 6a and 6b and bolts 42 pass through the rear side of outer sleeve 41 and are threadably secured in internal member 40. The ends of outer sleeve 41 are shaped so as not to have sharp corners or edges on at least the front side of rail assembly 2, to avoid the risk of injury to horses. Connection assembly 7 is intended to tightly grip the ends of sections 6a and 6b to ensure they do not separate under normally expected impacts to barrier fence 1.

Other connection arrangements, described later, are possible and may be used if desired and if suitable to a particular application. For example, FIG. 22 shows a cross-sectional view, intended to be directly comparable with FIG. 21, of an alternative connection assembly 50. Assembly 50 comprises an internal member 51 that closely fits in the spaces 8 at the ends of rail sections 6 to be joined (eg 6a, 6b), an external clamp member 52 and bolts 53 securing clamp member 52 and internal member 51 together. Clamp 52 and internal member 51 are shaped to hold rail sections 6a and 6b tightly around internal member 51. The adjoining ends of sections 6a and 6b are rounded off or otherwise smoothed to avoid any sharp edge where they abut. Connection assembly 50 and matching rail sections can provide a rail assembly similar to rail assembly 2 but without the lack of smoothness due to external sleeves such as sleeve 41.

With suitable choices of materials and dimensions, barrier fence 1 as described above can deflect to a degree under likely impacts from horses and/or jockeys, is resilient so as to spring back to its original shape in cases of comparatively light impacts, and can under heavy and impact-type loads collapse locally in such a way as to limit the risk of injury to the horses and/or jockeys.

Under comparatively light impacts, the rail assembly 2 can locally bend away from an impacting horse or jockey without individual rail sections such as 6a and 6b separating from each other. This bending away is partly due to bending of the rail assembly 2 itself, and partly due to bending of the uprights 3 about their lower ends. In addition, the rail assembly 2 rises slightly as it bends, thus, it is believed, progressively increasing the tendency for a horse nudging rail assembly 2 to withdraw from the rail assembly 2.

If a jockey or horse happens to fall over the top of rail assembly 2, probably while still moving forward as well, the fact that the uprights 3 extend downwardly and rearwardly from points close behind the rail assembly 2 means that the chance of injury through contact with (or even impaling on) uprights 3 is less than it would be with uprights shaped as shown at 14 in FIG. 3.

Under sufficiently heavy lateral impact in the direction of arrow 15 in FIG. 3, the connection between upright 3 and the ground 4 may be broken, but with the upright(s) 3 involved remaining connected to rail assembly 2 and able to swing freely until and unless they swing through a substantial angle—far enough for ball members 21 to leave slot 9. Breaking under impact of the connection between an upright 3 and ground 4 can be in any of several ways. Firstly, pin 33 may be so proportioned as to act as a shear pin, allowing foot 26 to leave the space 29. The tapering of foot 26 and space 29 is believed to enhance the reliability of component 11 leaving ground anchor 5 in this way under impact conditions, by comparison to an untapered body 26 (although that is not to preclude the possibility of foot 26 being untapered). Either the upper or the lower surface of foot 26, or both, may be made sloping.

Secondly, stub 27 can be provided with a suitably proportioned groove 34 (or otherwise weakened) so as to break under impact loads, by tube 12 and an upper part of stub 27 separating from the foot part 26 of body 11. In either case, it will be noted that ground anchor 5 stays embedded in ground 4 and that after the lower portion of upright 3 carries away there is nothing that protrudes substantially above ground 4 and that could represent a hazard to a falling horse or jockey.

Providing both carrying-away mechanisms for separation of a part of the above-ground portion of barrier fence 1 from its ground anchors 5 is believed to be advantageous. For example breakage of stub 27 at groove 34 could be arranged to occur under a specified impact load applied directly to upright 3, with ejection of foot 26 from space 29 being arranged to occur under a specified (and different) impact load applied laterally to rail assembly 2. Thus the barrier fence 1 may be “tuned” by design to respond in predictable and different ways to different types of impact loads. The choice of orientation of ground anchors 5 (i.e. choosing the angle 37) or of the insert 64c used with ground anchor 60 (see below) can also enhance the degree of control of behaviour of barrier fence 1 under different types of impact loads.

Alternatively, and it is thought more easily, barrier fence 1 may be designed so that failure of shear pin 33 and ejection of foot 26 from space 29 occurs in response to impact loads applied directly to tube 12, with reliance being placed on failure of stub 27 at groove 34 for carrying away under excessive rearward loads applied to rail assembly 2. Note that plate 31 of ground anchor 5 holds down foot 26 and so resists the rotation of foot 26 that tends to occur in response to rearward loads applied to rail assembly 2. Groove 34 may be non-uniform in a peripheral direction around stub 27 so that breaking off of stub 27 is more likely in response to rearwardly directed loads applied to rail assembly 2.

The ground anchor 5, foot 26 and pin 33 are believed able to provide a useful difference in response to loads applied at the height of rail assembly 2 and loads applied lower down, to an upright 3, even without the provision of a separate failure mechanism. If a horizontal impact load is applied close to the lower end of an upright 3, in a direction having a component at least partially along direction 39, pin 33 can fail in shear at a certain value of the impact load. However, if an equal horizontal load is applied higher on upright 3, or on rail assembly 2, the effect at the base of upright 3 is to apply both a shear force to pin 33 and a torque to foot 26 that tends to force end 200 of foot 26 upward against the lower face of top plate 31. Friction between foot 26 and top plate 31 then tends to resist movement of foot 26 out of the space 29, adding to the shear resistance provided by pin 33. Thus, the lateral impact force at the top of upright 3 required to cause its lower end to separate from ground anchor 5 exceeds the lateral impact force required if the load is applied further down, or at the base of, upright 3.

This too is believed to be advantageous because it further assists design of the fence 1 to resist a certain degree of nudging of rail assembly 2 by horses, while allowing an upright 3 impacted lower down (for example by a jockey sliding under the rail assembly 2) to carry away and reduce the potential for injury.

This effect can be enhanced if desired by providing high-friction surfaces on either or both of the upper surface of foot 26 and the lower surface of top plate 31. These surfaces could for example have serrations (not shown).

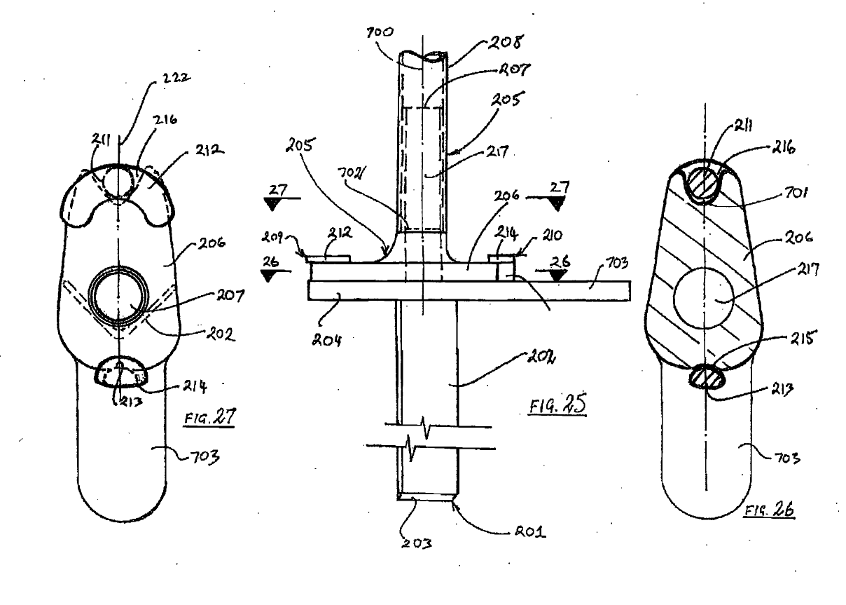

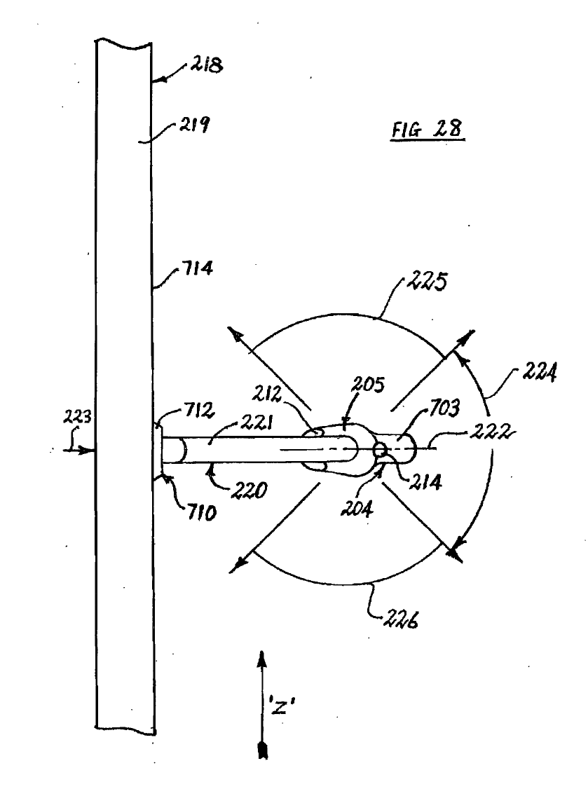

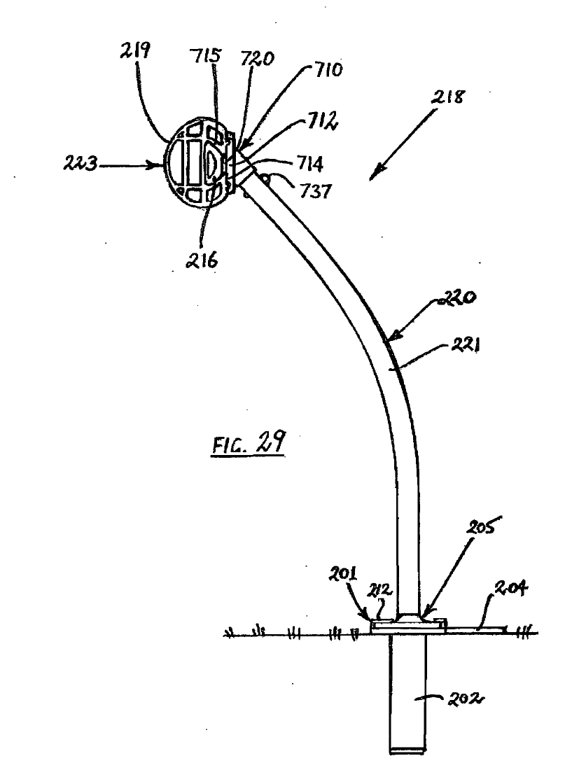

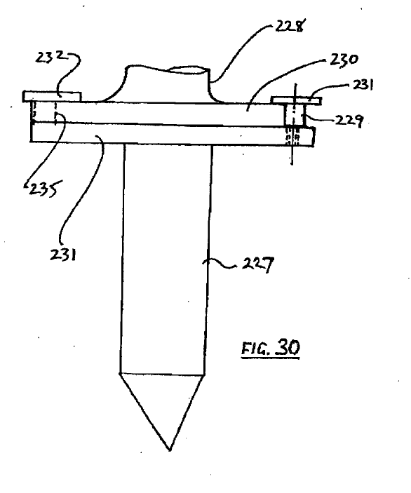

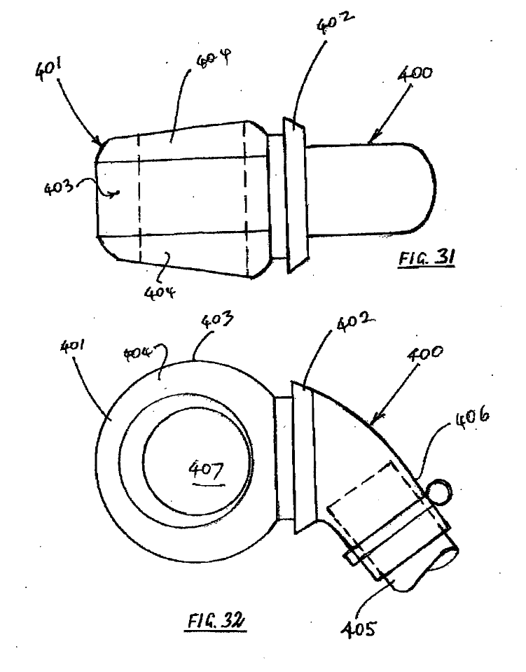

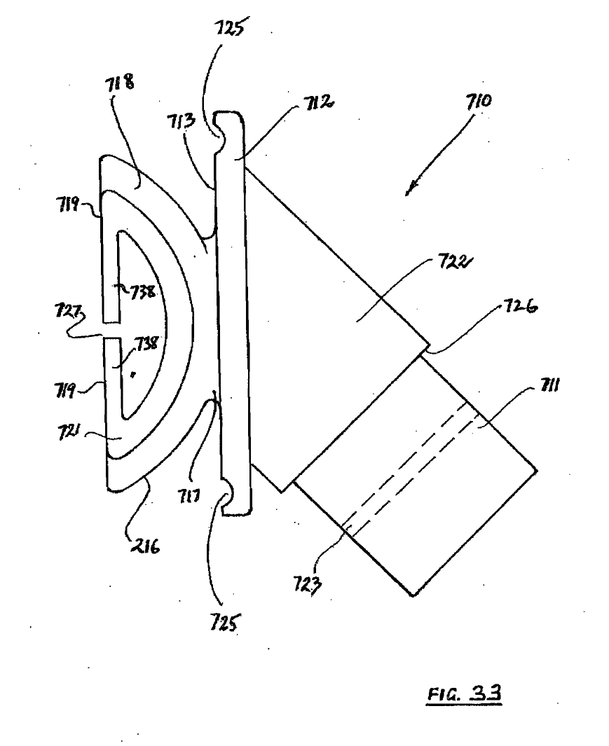

A variation is now described to the way in which the upper end of uprights 3 can be connected to rail assembly 2, by reference to FIGS. 23 and 24. Rather than having the upper end fittings (such as 10) on uprights (such as 3) able to rotate completely freely, they may be provided with a form of detent, whereby the upright has a preferred position, for example one in which the plane in which the uprights 3 lie is normal to the length of the rail assembly 2. This can be achieved with upright upper end fittings 301 that are similar to fittings 10 except for having grooves 302 that in the preferred or detent position receive elongate projections 303 on rail section 304. To avoid excessive restraint against free rotation of fittings 301 in rail sections 304, it can be arranged that projections 303 do not fully fill grooves 302. It will be understood that an equivalent arrangement, not shown, in which the grooves are on the rail section and the projections are on the fittings, is also possible.

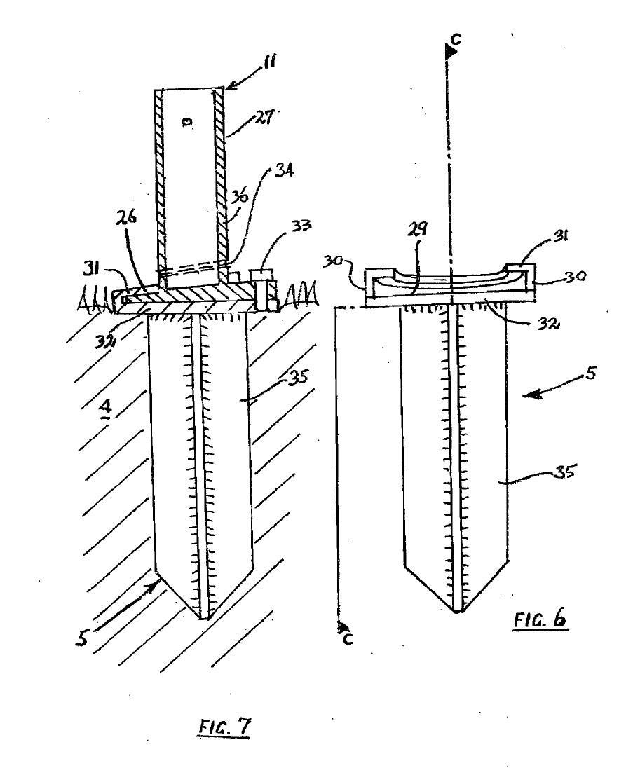

FIG. 8 shows a ground anchor assembly 60 that is an alternative to ground anchor 5. Assembly 60 comprises firstly a tubular in-ground member 61 with a pointed bottom section 62 to facilitate driving into the ground 4 until upper rim 63 is approximately level with the surface of ground 4. Secondly, assembly 60 comprises an insert 64 that is tubular and fits closely into member 61. An upright 65 comprises a tube 66 (essentially the same as tube 12 of upright 3) but without fitting 11. Instead, the lower end of tube 66 simply fits closely over insert 64 where it extends above ground level. Under lateral impact loads, the connection between upright 65 and ground anchor 60 can be broken in any of several ways. In one of these, insert 64 may simply bend sideways until tube 66 pulls longitudinally off the upper part of insert 64 or insert 64 is pulled out of member 61. In another, insert 64 may be locally weakened to fail (eg by shearing off) close to ground level. FIGS. 9-12 show three possible versions of insert 64 that achieve this. Tubular insert 64a (FIG. 9) has a circumferential groove 67 to define a breakage area. An O-ring 68 may optionally be placed in groove 67 to lodge inside the tubular upper part of anchor 61 and also limit water draining into the lower part of anchor 61.

FIG. 10 shows an alternative tubular insert 64b in which weakening near ground level is provided by a simple through-hole 69.

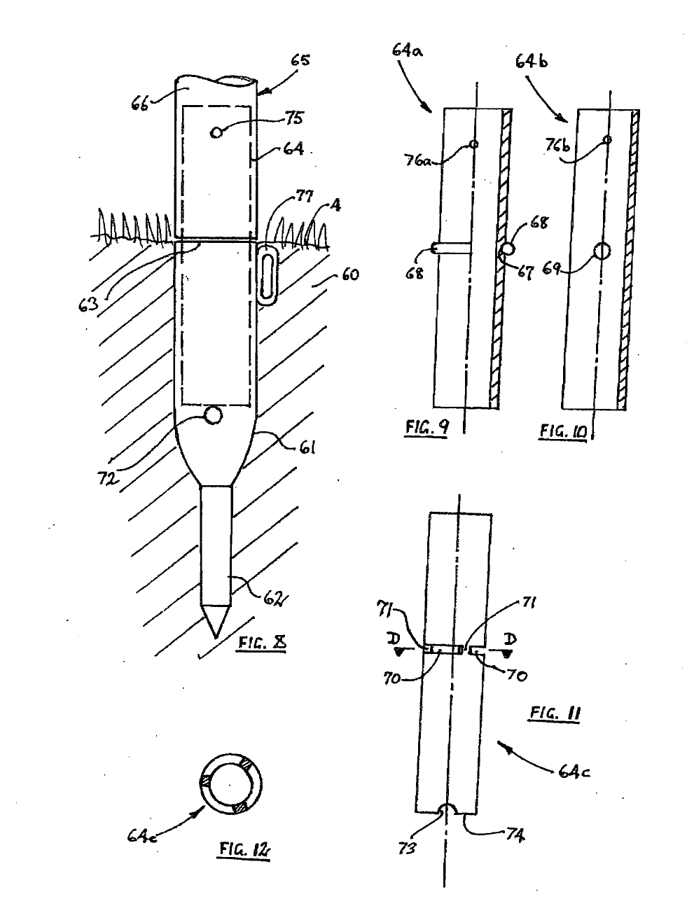

FIGS. 11 and 12 show another alternative insert 64c in which weakening near ground level is provided by part-circumferential cutouts 70 leaving connecting stems 71. Tubular member 61 has a fixed rod 72 extending diametrically therethrough, and insert 64c has a recess 73 in its lower edge 74 that fits over rod 72 so as to control the orientation of the cutouts 70 and stems 71. In this way, it is possible to control the direction in which breakage of insert 64c is most likely to occur.

Insert 64 (or 64a, 64b or 64c) may be pinned to tube 66 by a pin 75 passing through a hole 76 (or 76a, 76b, or 76c). A ring member 77 is provided on member 61 to facilitate withdrawal from ground 4 if required for example during relocation of the barrier fence.

It is of course possible to provide a ground anchor (not shown) that has a below-ground part similar to (or the same as) the ground anchor 60, but with an upper portion functionally the same as that of ground anchor 5.

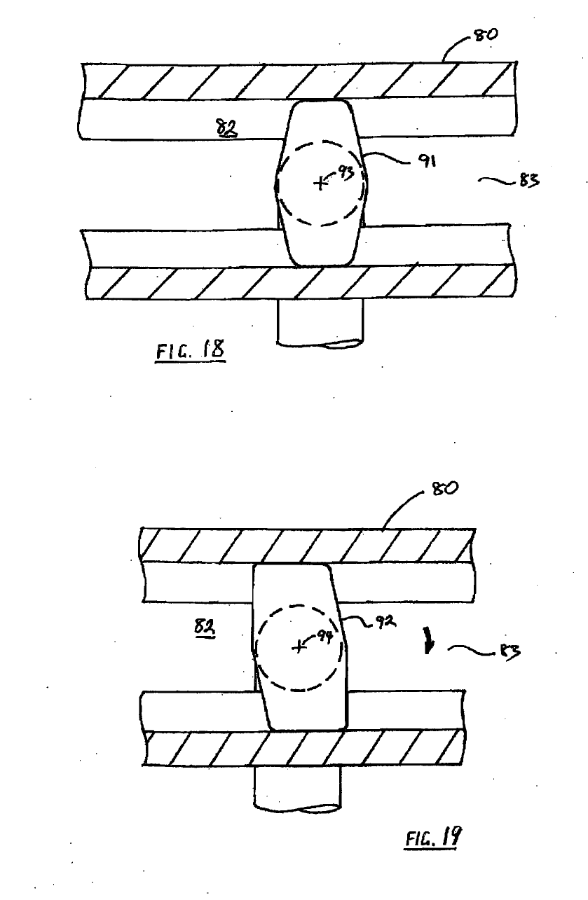

FIG. 16 is a cross-sectional view of a rail section 80 that is an alternative to the section 6, and an upper portion of an upright 81 that is an alternative to upright 3. Rail section 80 has an internal space 82 and a slot 83 along its length (respectively equivalent to space 8 and slot 9 of section 6). Upright 81 includes a fitting 84 secured within the upper end of a tube 85 (like tube 12), that in turn includes a connecting member 90 passing through slot 83 and a plate-like part 86 that fits closely within space 82. As shown in FIG. 17, part 86 is in the form of a disc. If the lower end (not shown) of upright 81 separates from its ground anchor (not shown) this arrangement permits upright 81 to rotate about an axis 87 without separating from rail section 80. If required, fitting 84 can be secured to tube 85 by a shear pin 88 so that even tube 85 and fitting 84 can separate under impact.

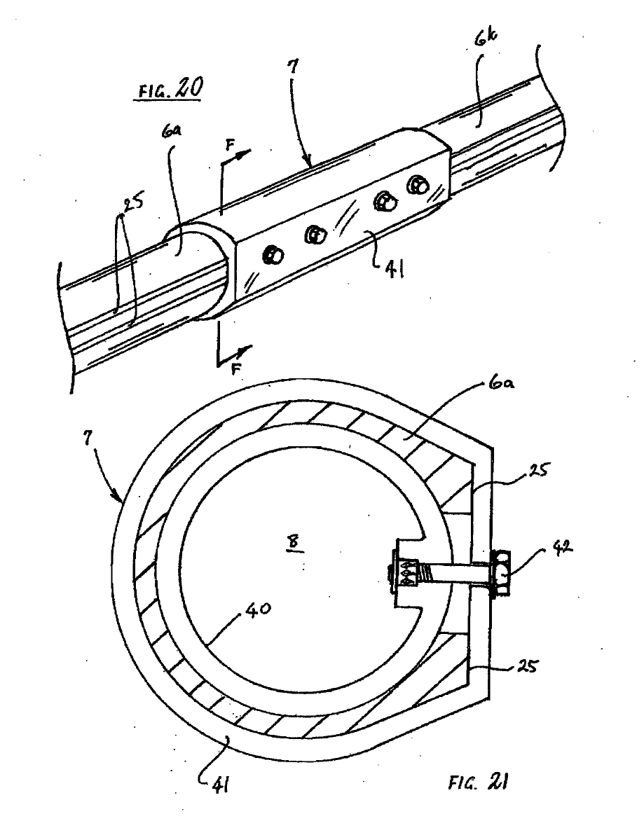

Possible modifications of the arrangement of FIGS. 15 and 16 are shown in FIGS. 18 and 19. These differ from the arrangement of FIGS. 15 and 16 only in the shape of the plate-like members 91 and 92 that are alternatives to plate-like member 86. Members 91 and 92 are shaped and sized so that in a particular orientation about their respective axes 93 and 94, they can be pushed in through slot 83 (like ball member 21 of upright 3) without having to be fed in through the end of rail section 80, and then rotated into the operative positions shown. By suitable control of the shape of members 91 and 92 and their clearance in space 82 it is possible to control the torque required to make members 91 and 92 rotate about axes 93, 94, further enhancing the degree to which the behaviour of a barrier fence under impact loads can be controlled.

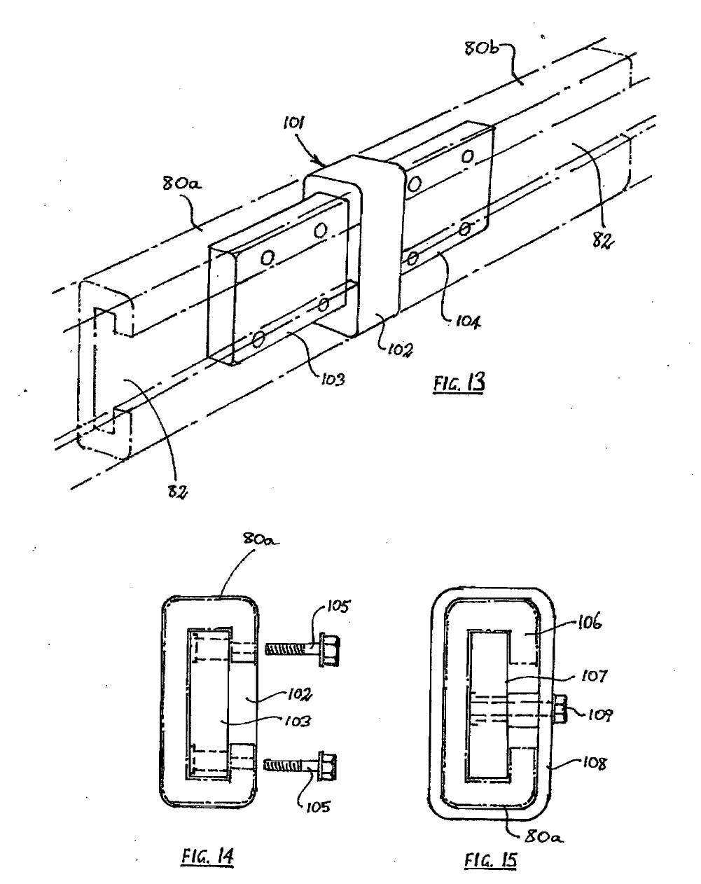

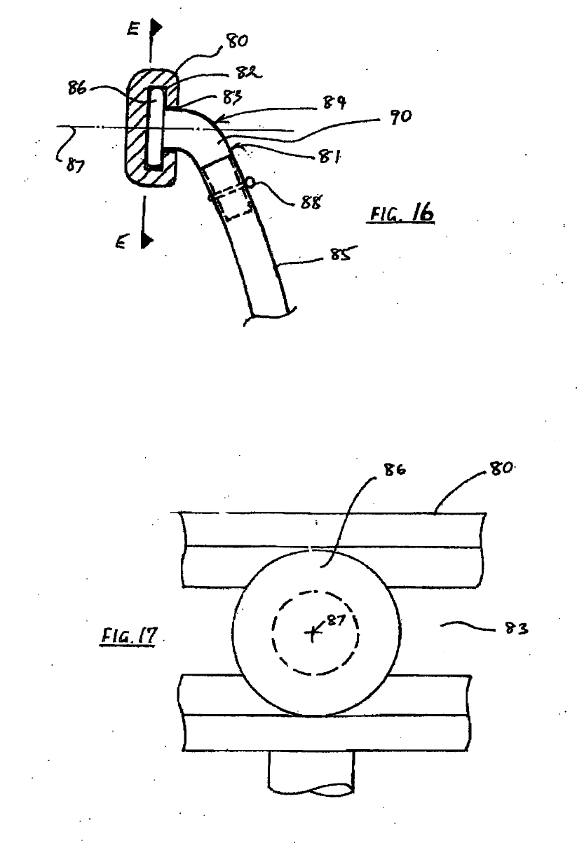

FIGS. 13 and 14 show an alternative connection assembly 100, as applied to the end-to-end connection of rail sections 80a and 80b (the same as section 80). A member 101 has firstly a central section 102 that is sized and shaped (when seen end-on as in FIG. 14) similarly to the cross-section of rail sections 80a, 80b and secondly tangs 103 and 104 that extend lengthwise in opposite directions and are shaped and sized to snugly enter spaces 82 of sections 80a, 80b. Bolts 105 pass through sections 80a and 80b and into tangs 103 and 104, thus connecting rail sections 80a and 80b while ensuring that the upper lower and front sides of the assembly of sections 80a, 80b and 101 are of constant cross-section.

A modification of this arrangement is shown in FIG. 15 which is from a similar viewpoint as FIG. 14. In this arrangement, a connecting member 106 is provided that is the same as member 101 except that threaded bolt holes are provided in tangs 107 (equivalent to tangs 103, 104) in a different position. An external sleeve 108 close-fittingly surrounds rail sections 80a and 80b and member 106 and is bolted to tangs 107. (Although not shown, sections 80a and 80b may also be bolted to tangs 107.)

There will now be described a further barrier fence 218 that is different from and is preferred over barrier fence 1. Certain barrier fences that are variations to fence 218 are also described. Refer firstly to FIG. 28. Barrier fence 218 has a continuous elongate rail assembly 219 (corresponding to rail assembly 2 of barrier fence 1 and formed of lengths of rail joined end to end as for barrier fence 1) supported by uprights 220 (corresponding to uprights 3 of barrier fence 1) and has ground anchors 201 (corresponding to ground anchors 5 of barrier fence 1).

FIG. 28 shows in plan view a portion of barrier fence 218 comprising rail assembly 219 and an upright 220 secured to rail assembly 2 in the same way as in barrier fence 1 upright 3 is secured to rail assembly 2. The bottom end of an arcuately bent tube 221 (like tube 12) of upright 220 is received on stub 207 of a fitting 205, and fitting 205 is mounted to a ground anchor 201 that is described below. Line 222 lies in the plane that contains the axis of tube 221 and so is normal to the length of rail assembly 219.

FIG. 25 shows a ground anchor assembly 201 having a lower section 202, with sharpened lower edge 203 that is adapted to be driven into the ground, and a top plate 204. Lower section 202 may be of any suitable cross-sectional shape and is shown (see phantom lines in FIG. 27 only) as being formed of hot-rolled steel equal angle in an orientation that enhances the resistance of ground anchor to overturning in the ground under rearwardly directed sideloads applied to rail assembly 219. Anchor 201 is able to be driven into the ground (not shown) in a similar manner to ground anchors 5 and 61, so that plate 204 is close to, approximately flush with or bearing against, the ground surface.

Secured to ground anchor 201 is a bottom fitting 205. The breakaway mechanism provided by ground anchors 201 and fittings 205 constitutes an important difference between barrier fence 218 and barrier fence 1. Fitting 205 has a plate 206 that in use sits above and bears against plate 204, and an upstanding stub 207 that fits into a lower end of a tubular upright member 208 (similar to tube 12). Fitting 205 has an optional hole 217 extending through it, coaxially with stub 207. Plate 206 is held in place by two formations 209 and 210 that are secured to top plate 204.

Also to enhance the resistance of ground anchor 201 to overturning in the ground under rearwardly directed sideloads applied to rail assembly 219, plate 204 has a rearwardly directed extension 703 whose lower surface abuts the ground.

Formation 209 has an upstanding pin 211 and a plate 212 that is secured to an upper end of pin 211. Plate 206 fits snugly between plates 212 and 204. Pin 211 is “matingly” received in a recess 216 in plate 206. The word “matingly” as used here is described below. Formation 210 has an upstanding pin 213 and a plate 214 that is secured to an upper end of pin 213. Plate 206 also fits snugly between plates 204 and 214. Plate 206 has a shallow recess (dimple) 215 that is shaped to matingly accommodate a portion of pin 213. The shapes and proportions of pins 211 and 213, recess 216 and dimple 215 are such that plate 206 is held snap-fittingly by and between pins 211 and 213 with substantially no free play, but such that plate 206 can be dislodged by urging it with a comparatively small force in a direction perpendicular to a line 222 between pins 211 and 213, compared to the large force which would be required to move plate 206 along line 222.

Turning to use of the word “matingly” above, it will be noted that where pin 211 is received in recess 216, there is a clearance 701 on centerline 222 so that pin 211 bears against only the sides of recess 216. This is to ensure that when plate 206 is pushed into place between pins 211 and 213, plate 206 is slightly under compression. This has been found desirable to enhance the snap-fitting retention and subsequent release of plate 206 between pins 211 and 213.

It has also been found desirable that tube 221 be able to rotate about the longitudinal axis 700 of stub 207. This aids in positioning plate 206 in engagement with ground anchor 201 and in obtaining its satisfactory release also.

In response to a horizontal load (represented by vector 223) applied in a rearward direction to the rail assembly 219, tube 221 bends as required, but plate 206 of fitting 205 is held very securely between pins 211 and 213 and between plates 204 and both 212 and 214. Vector 223 is representative of a load that might be applied by a horse nudging rail assembly 219 for example. Plate 212 acts to prevent rotation of plate 206 under such loads 223, as plate 206 is urged upwardly against plate 212 under such loads.

However, a horizontal load 227 applied directly to upright 220 or fitting 205, for example by a jockey falling underneath rail assembly 219 has an effect that depends on the direction of the impact. It has been found that if such a load is in the direction of line 222 (as seen in FIG. 28) or within a certain angular range (represented by arrow 224) that includes line 222 and extends on either side of line 222, then fitting 205 will remain in place. But if the horizontal load on upright 220 is directed within either of the ranges represented by arrows 225 and 226, it has been found that fitting 205 will slide off ground anchor 201, so minimizing the chance of injury to the jockey. The ranges 224, 225 and 226 can be influenced by the design of fitting 205 and ground anchor 201.

Thus, barrier fence 218 can be designed to be very secure against actual carrying away of lower ends of uprights 220 in response to likely loads on rail assembly 219, but with those lower ends being able to carry away under loads applied to uprights 220 for example by riders (or horses) falling underneath rail assembly 219. It will be noted that the presence of both ranges 225 and 226 allows racing in both directions along fence assembly 218. (On the other hand, there is no necessity for line 222 to be perpendicular to the length of rail assembly 219, and a different orientation may be preferable if racing is normally in one direction only.

Instead of dimple 215, plate 206 could have other types of formation to engage pin 213.

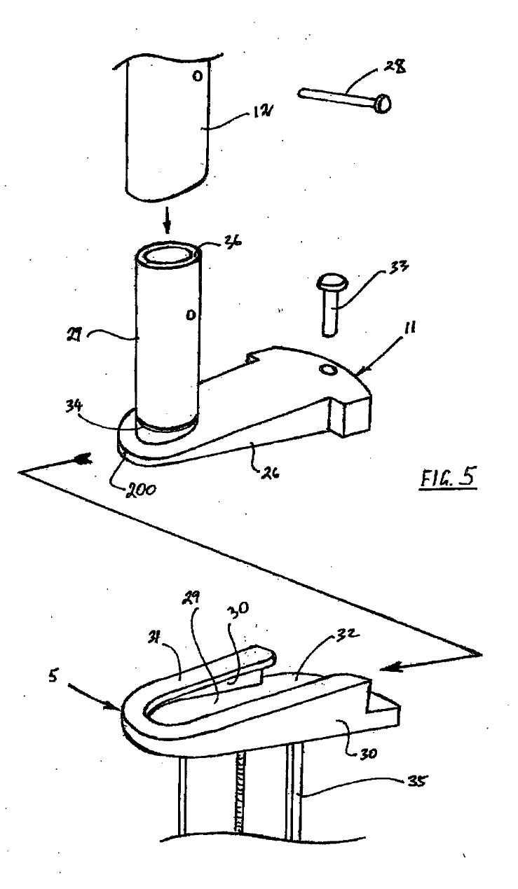

Note that the junction between stub 207 and plate 206 may be filleted as shown, optionally including having a larger radius fillet facing plate 212 and a smaller radius fillet facing plate 214 to avoid stub 217 itself failing there under impact loads. Measures such as those described above by reference to FIGS. 5 (item 34) and 9-11 are preferably provided to enable predictable carrying away under loads not applied to upright 220 in the angle ranges 225 or 226. As a specific example, a groove 702 may be provide at the base of stub 207 as a “weak point” so that under large side loads applied rearwardly (as load 223) to rail assembly 219 it is possible for tube 221 and stub 207 of the upright 220 to separate from fitting 205 and ground anchor 201. The load 223 at which this occurs can be chosen quite independently of the impact load on upright 220 at which plate 206 is released from between pins 211 and 213, an advantageous feature.

It is desirable if stub 207 does break that it be retained in the lower end of tube 221 to avoid becoming hazardous to riders or horses. Although not shown, it is possible to provide for this. For example a pin or screw could be arranged to pass through one wall of tube 221 with an end of the pin or screw being received in another groove in stub 207 so as to prevent lengthwise movement of stub 207 in tube 221.

FIG. 30 shows a modified version of the arrangement (ground anchor 201 and fitting 205) shown in FIGS. 25-29 that can also allow carrying away under loads applied in the angle range 224. Ground anchor 227 is essentially the same as ground anchor 201 and fitting 228 is the same as fitting 205, except that instead of formation 210 there is provided a shear pin 229 that is secured to (for example by threadably engaging) plate 231 (equivalent to plate 204) and that in normal use plays the role of pin 213. This includes the manner of holding plate 230 (equivalent to plate 206) between pin 229 and pin 235 (equivalent to pin 211). Pin 229 has a head 231 that in normal use acts in the same way as plate 214. However, in response to a sufficiently high horizontal load applied to fitting 228 or tube 221 in the angle range 224, shear pin 229 can fail so that fitting 228 can slide off ground anchor 227. Thus the range of angles within which a jockey or horse can impact an upright 220 and expect it to carry away can be extended. As in the case of the arrangement shown in FIGS. 5-7, a difference in response to loads applied at the height of rail assembly 219 and loads applied to upright 220 or fitting 228 can be secured by suitable design (including the optional use of a roughened upper surface on plate 230 and/or a roughened lower surface on plate 232 (equivalent to plate 212). Plate 230 could even be tapered like foot 26.

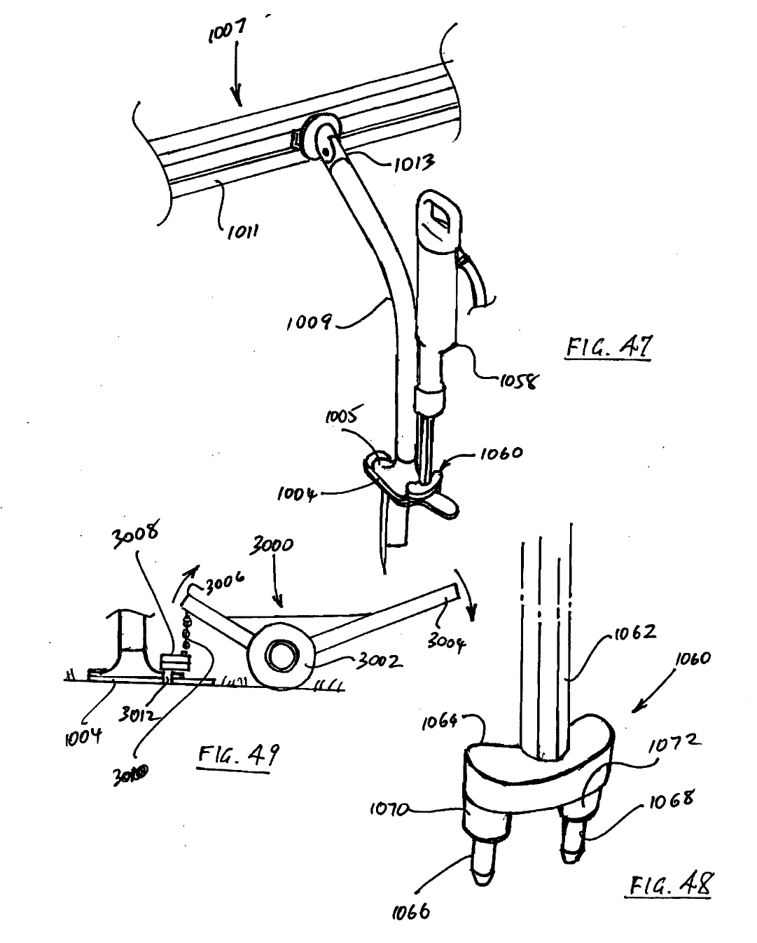

Note that a further and functionally similar shear pin arrangement is also described below in the discussion that refers to FIGS. 45 and 46.

The ground anchor 227 is shown without a rearward extension corresponding to extension 703 shown in FIGS. 25-27, but such an extension could of course also be provided.

Barrier fence 218 has another difference from barrier fence 1 in the arrangement at the upper end of its uprights 220, which will now be described. Referring to FIGS. 29, 33 and 34, it will be seen that the upper end of tube 221 is secured on a stub 711 of an upper end fitting 710. Fitting 710 has a flange 712 with a forward-facing surface 713 that abuts a rearward facing surface 714 of rail assembly 219. Close-fittingly received in an internal space 715 of rail assembly 219 is a formation 216. Formation 216 is connected to flange 712 by a neck 717 and has a part-spherical surface 718 and flat surfaces 719 that abut matching surfaces defining the boundary (in transverse cross-section) of space 715. Surfaces 719 are on formations 738 and there is a gap 727 between formations 738. This is so that the portion of fitting 710 that lies within space 715 can be so made (for example by injection moulding in plastics) as to spring outward against the inner surfaces of space 715. Neck 717 is received in a slot 720 that extends along rail assembly 219 and connects internal space 715 to the exterior of rail assembly 219. Formation 216 has parallel end faces 721 that are so spaced apart as to enable formation 216 to be entered into internal space 715 through slot 720 when upright 220 is rotated to a horizontal position. However, when upright 220 is rotated downwardly to the position shown in FIG. 29, the fitting 710 is captive in rail assembly 219, although able to rotate about a horizontal axis if the lower end of upright 220 breaks away as described above.

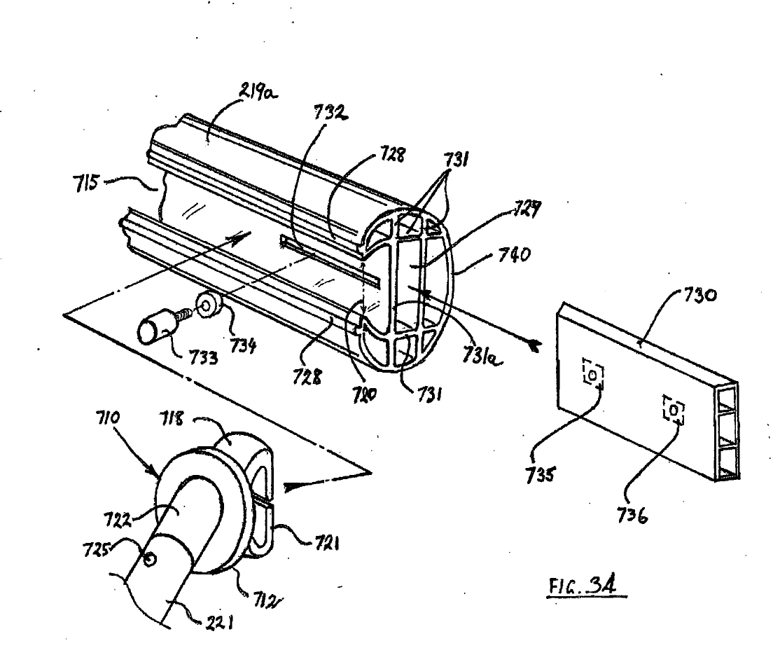

Parallel grooves 725 are formed in surface 713 of flange 712. Their purpose is to act as part of a detent mechanism as described above by reference to FIGS. 23 and 24. FIG. 34 shows raised elongate formations on rail assembly 219 that mate with grooves 725.

Fitting 710 has the advantage over fittings such as fitting 10 of being smaller and requiring less material.

Stub 711 is an extension of a transition piece 722 that has a shoulder 726 for the upper end of tube 221. A hole 723 is provided through stub 711 for a pin 737 (FIG. 29) whereby fitting 710 is locked to tube 221.

Note that stub 711 (hence tube 221) extends rearwardly and downwardly at a substantial angle (shown as about 45 degrees but preferably between about 40 degrees and about 60 degrees) below the horizontal and that stub 711 and transition piece 722 are very close to flange 712. These factors together with the smooth arcuate shape of tube 221 contribute to upright 220 presenting a comparatively small hazard to falling riders.

Tube 221 is shown as (and preferred to be) bent into a smooth arcuate shape (in a plane transverse to rail assembly 219) between stubs 711 and 207. The section between stubs 211 and 207 may be of substantially constant radius of curvature. Tube 221 is however straight where it is received on stubs 207 and 211.

FIG. 34 shows a portion of barrier fence 218 at an end of one 219a of the multiple rail lengths that are joined end to end to form rail assembly 219. Rail length 219a is shown as an extrusion of constant cross-section having partitions 731 within a peripheral cover 740. Such a construction is known in the barrier fence art. Fitting 710 can be entered into and made captive in internal space 715 of rail length 219a either by orienting fitting 710 so that formation 216 can pass through elongate slot 720 and then rotating to the position shown in FIGS. 29 and 34, or by being moved lengthwise into space 15 if an end of rail length 219a is accessible.

Also shown in FIG. 34 is a way of joining rail lengths such as 219a end to end that is additional to those described above by reference to FIGS. 2, 13, 14, 20, 21 and 22 and convenient when barrier fence 218 is being assembled. A movable elongate body 730 can be entered partly into a space 729 of rail length 219a, and partly into a corresponding space of another such rail length (not shown) to join the rail lengths end to end. A bolt 733 can be passed through a slot 732 and engage in a captive nut 735 in body 730. When bolt 733 is tightened, body 730 is held tightly against partition 731a between nut 735 and a washer 734 on bolt 733. Another captive nut 736 is provided in body 730 and can be used with a bolt (not shown) like bolt 733 to firmly hold another rail length to length 219a, i.e. with no capacity for lengthwise relative movement between them. Alternatively at a joint between two rail lengths made with body 730, one can use only one of the captive nuts 735 and 736, so that relative longitudinal movement is possible to accommodate for example thermal expansion. Thus it is readily possible to provide a rail assembly 219 that consists of groups of individual rail lengths such as 219a joined together rigidly, with expansion able to be accommodated between these groups.

Note that a joint of the type shown in FIG. 34 between adjoining rail lengths such as 219a can be easily unmade, by sliding body 730 fully into one of the rail lengths 219a (with bolt 733 sliding along slot 732) so that the other is released.

Although not shown in FIG. 34, a close fitting external sleeve (analogous to those shown in FIGS. 2 and 20-22 may be secured over the end of rail length 219a to cover the actual ends between adjoining rail length ends and any gap between them, so that the rail assembly 219 appears continuous and externally smooth.

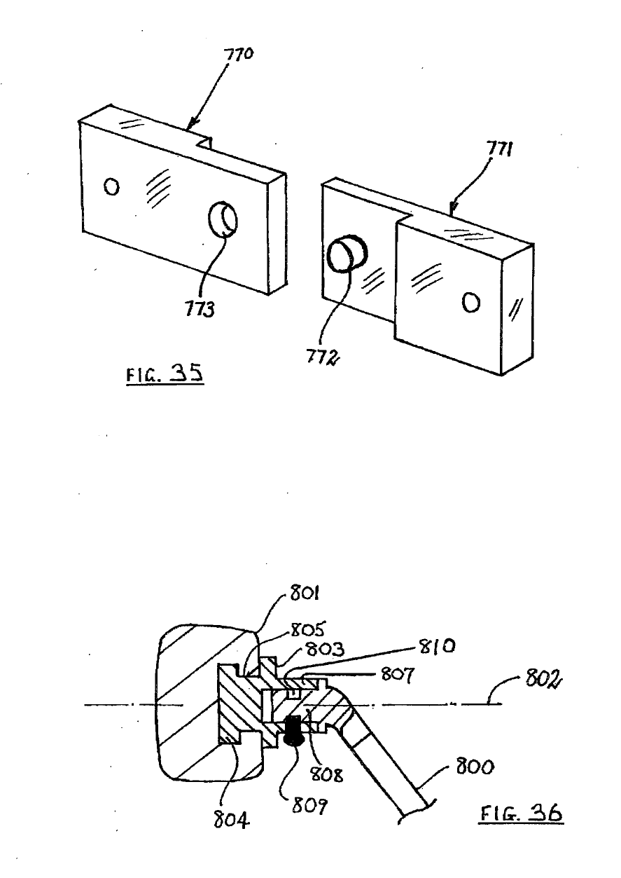

As an alternative to body 730, FIG. 35 shows two interlocking parts 770 and 771 that can do essentially the same thing. Body 770 can be entered slideably into space 729 in a right hand end of rail length 219a and (like body 730 in FIG. 34) be retained there by bolt 733 which slides in slot 732 and can be received in a threaded hole 774. Similarly, body 771 can be entered into the corresponding space at a left hand end of a rail length (not shown) to be connected to rail length 219a, and slid lengthwise or secured by a bolt in the same way. Body 771 has a boss 772 that can be close fittingly received in a hole 773 in body 770 to prevent longitudinal relative movement of the bodies 770 and 771. When the two bodies 770 and 771 are thus connected, withdrawn into their respective rail lengths and secured by bolting, the two rail lengths are held together.

Yet another upright upper end fitting 400, shown in FIGS. 31 and 32, is now described, that is an alternative to such fittings as 10, 301, 84 and 710. Fitting 400 is used in essentially the same way as fitting 10 (for example) and does what that fitting does, as described above. It has a part 401 (corresponding to ball member 21) that is received in a rail (like rail 6, not shown), and a flange 402 (corresponding to flange 19) that bears against the rear of that rail. It differs from fitting 10 in the following respects:
(a) Part 401 has a cylindrical surface 403 and curved surfaces 404, the surface 403 lying against the internal surface of the rail in normal use. During placement of fitting 400 and an attached upright (not shown) into a rail, and in the event of a lower end of the upright carrying away from its ground anchor, so that part 401 must rotate within the rail, surfaces 404 can bear against the internal surface of the rail just as the surface of member 21 does. The presence of surface 403 provides another form of “detent” action, so that member 400 tends to “snap” into a preferred orientation in the rail.
(b) Part 401 is tapered, becoming wider as shown in plan view from its front side to its rear (flange) side. This provides a “snap in” action when fitting 400 is fitted into the rail, and helps limit any tendency of fitting 400 to pop out of the rail in the event of large rotations of fitting 400. (Compare with FIG. 3, plan view of 10.)
(c) Fitting 400 has a female sleeve section 406 to receive upright tube 405 rather than a male stub that extends into tube 405.

FIG. 36 shows an alternative way of providing for an upright 800 to be secured to a rail assembly 801 (seen in transverse section) and for its upper end to be able to rotate about a horizontal axis 802 if the lower end (not shown) of upright 800 breaks away. A fitting 803 (seen in section) has a section 804 that is retained in a space in rail assembly 801 and extends out through a slot 805. An outer section of fitting 803 comprises a short tubular section 807, in which a stub axle 808 secured to an upper end of upright 800 is received and can rotate about the axis 802. A pin 809 in a wall of tubular section 807 is received in a peripheral groove 810 in stub axle 808 to retain stub axle 808 within tubular section 807. This arrangement is believed more difficult to make compact (and so less harmful in the event of a rider falling from above) than the other arrangements described herein.

There will now be described a set of still further embodiments, optional features and erection methods, applicable particularly to fences made on the general principle of fence 218. These can be summarized as follows:
(aa) A barrier fence may be provided that is generally similar to fence 218, but whose bottom fitting (equivalent to fitting 205) is not snap-fittingly engaged in the ground anchor (equivalent to ground anchor 201).
(bb) Provision may be made to ensure that where the bottom fitting of an upright (such as upright 220) parts company from its ground anchor under impact, the risk of the upright separating from the rail assembly to which it is attached is reduced for certain types of upright top end fitting, in particular fittings such as fitting 710. Provision may also be made to ensure that where the bottom fitting of an upright parts company from its ground anchor under impact, the risk of the upright causing injury through excessively rapid rotation is reduced.
(cc) Further methods for joining rail extrusions are provided.
(dd) Methods for erecting and dismantling barrier fences are provided.
(ee) Provision may be made to ensure that where the bottom fitting of an upright parts company from its ground anchor under impact, the upper end of the upright can rotate not only about an axis extending transverse to the rail assembly, but about another axis, so as to further reduce the potential for injury.
(hh) It is possible to provide for one or more “preferred” barrier fence positions where erection of a barrier fence is quicker, easier and less likely to damage to ground surfaces than erection in other positions.
(ii) An additional arrangement for connection of upright tubes to their bottom end fittings to enable rotation during fence assembly is provided.

These are discussed below, in turn.

### (aa) Non-Snap Fitting Upright-to-Base Connection

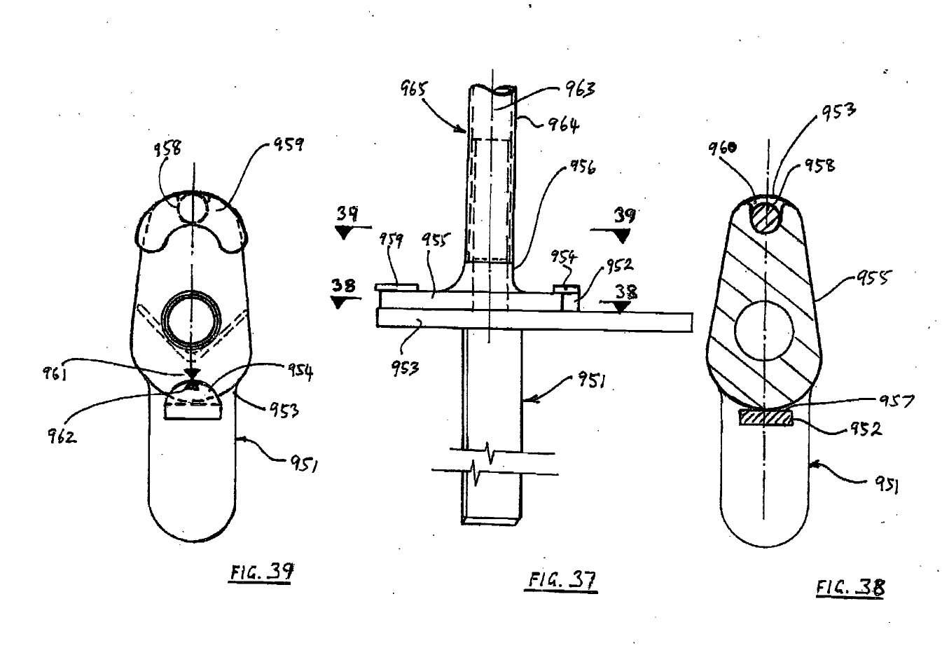

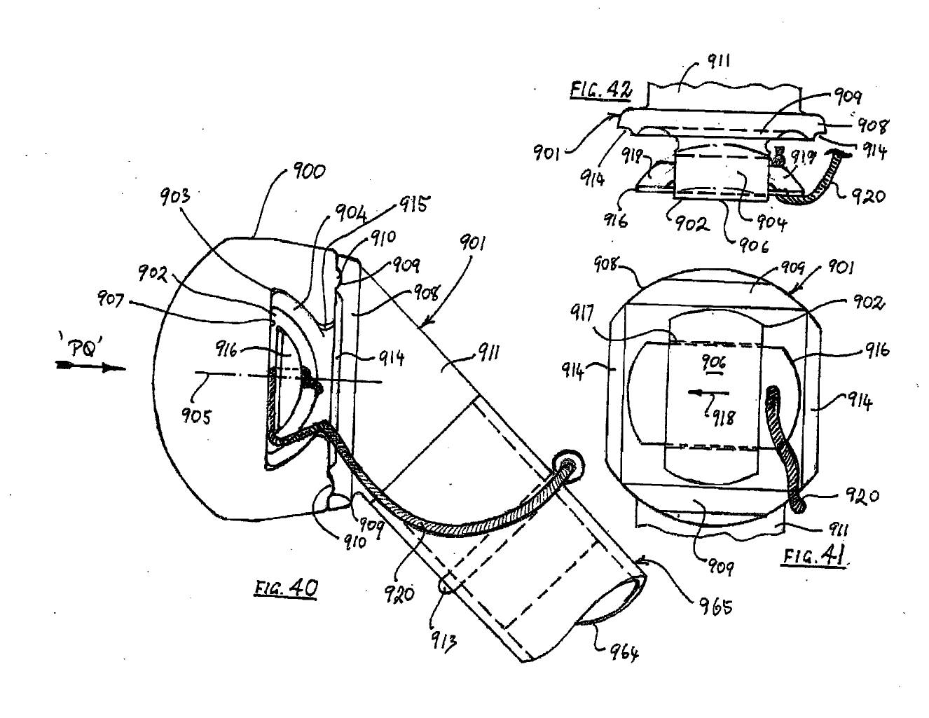

Refer to FIGS. 37, 38 and 39. These figures may be compared directly with FIGS. 25, 26 and 27 respectively. A ground anchor assembly 951 is essentially similar to ground anchor assembly 202 (FIG. 25) and only the differences will be described. A formation 952 extends upwardly from horizontal plate 953 (corresponding to plate 204 in FIG. 25) and has thereon a plate 954 that extends partly over a plate 955 (corresponding to plate 206 in FIG. 25) that is part of a bottom fitting 956 (corresponding to bottom fitting 205 of FIG. 25). Instead of being received in a recess like recess (dimple) 215 of FIG. 26, formation 952 simply has a flat surface 957 that lies close to or against an edge of plate 955. Plate 955 fits snugly between plates 953 and 954. A pin 958 and plate 959 are essentially the same as pin 211 and plate 212 of FIGS. 25 and 27, the plate 955 being snugly held between plate 959 and plate 953. In the operating configuration shown in FIGS. 37, 38 and 39, pin 958 is received in a recess 960 in plate 955 at that plate's front end.

The essential difference between the arrangement shown in FIGS. 37-39 and that shown in FIG. 25-27 is that bottom fitting 956 is not snap-fittingly held in place on ground anchor assembly 951 as bottom fitting 205 is snap-fittingly held on ground anchor 201. Snap fitting of one part to another implies that to separate the parts from each other a force is required to be applied that first rises and then falls. Retention of fitting 956 can be ensured by either or both of the following mechanisms:
1. Friction between plate 955 on the one hand, and plates 953 and either or both of plates 954 and 959 on the other hand;
2. Friction between plate 955 and surface 957 and pin 958, with plate 955 being under a degree of compression between formation 952 and pin 958.

It has been found that avoiding snap-fitting as described can make smoother the carrying away of an upright's lower end under impacts in angle ranges such as those shown for fence 218 at 225 and 226 in FIG. 28.

To achieve compression of plate 955 between pin 958 and formation 952, the approach described by reference to FIGS. 25-27 may be used, namely to suitably shape recess 960 (corresponding to recess 216).

It is not essential in a non-snap-fitting arrangement as described above that surface 957 of formation 952 be flat. It could for example be rounded, for example like the pin 213 of ground anchor 201.

As with the arrangement shown in FIGS. 25-27, it has been found desirable that the bottom fitting 956 be able to rotate about an upright axis 963 relative to its associated upright tube 964, as this eases fence assembly.

It will be noted that the ground anchoring arrangement shown in FIG. 30 can also be adapted to operate in a non-snap-fitting manner if desired, enabling foot breakaway under side impact loads both in angle ranges equivalent to those shown (for fence 218) in FIG. 28 at 225 and 226 and the angle range shown at 224. This is not shown, but would be done by shaping the shear pin (equivalent to pin 229) and foot (equivalent to foot 230) in the way described above.

Marks 961 and 962 may be provided on fitting 956 and plate 954 to assist in correct positioning of fitting 956 on ground anchor 951. However, a shear pin may also be provided to accurately locate the bottom fitting of an upright on its ground anchor in non-snap-fitting arrangements. For example, as a modification (not shown) of the arrangement shown in FIGS. 37-39, a shear pin could be provided to pass through a hole in plate 955 and downwardly into another hole in plate 953. Such a pin would be able to be put in place only with the ground anchor 951 and bottom fitting 956 in the correct operating position (so that the two holes would be in registration with each other). This shear pin could be proportioned to fail readily in shear on any impact applied to the upright 965, so as not to interfere significantly with the correct separation of the bottom fitting from the ground anchor on impact.

(bb) Retention of Upright Upper End Fittings in Rail Assembly and Limitation of Upright Movement after Impact

Refer to FIGS. 40, 41 and 42. In FIG. 40 a barrier railing 900 is seen in transverse cross-section, i.e. looking along its length, with all detail of the railing 900 being omitted save its actual outline. A fitting 901 is shown secured to railing 901, in its normal operating position. Fitting 901 has a coathanger-shaped (as seen in FIG. 40) portion 902 that is held close-fittingly and rotatably in an elongate cavity 903 in railing 900 in the same way as described above for fitting 710. That is, portion 902 has a surface 904 that is part of a sphere, and a flat surface 906 transverse to axis 905 that abuts a corresponding flat surface 907 of cavity 903, so that fitting 901 can rotate about a horizontal axis 905 transverse to the rail. Fitting 901 has a flange 908 and grooves 909 (corresponding to flange 712 and grooves 725 of fitting 710). Grooves 909 in the operating position shown matingly receive formations 910 of railing 900 to provide a detent effect, tending to hold fitting 901 in its correct position. Extending backwardly and downwardly from flange 908 is a stub 911 to which a tubular upright portion 964 is secured by a pin 913.

A first substantive difference of substance between fitting 901 and fitting 710 is that flange 908 has cutaways 914, so that if fitting 901 rotates through 90 degrees from the operating position shown, formations 910 enter cutaways 914 to provide a degree of detent action, tending to decelerate rotation of fitting 901.

A second substantive difference of substance between fitting 901 and fitting 710 is as follows. Fitting 901 is secured to railing 900 by entering portion 902 into cavity 903, through elongate opening 915 and then rotating fitting 901 through 90 degrees to the position shown in FIG. 40. However, if the upright of which it is a part carries away at its lower end, and rotates through 90 degrees about axis 905, it is then possible for portion 902 to exit through opening 915 so that fitting 901 parts company from railing 900. This could conceivably be hazardous. To prevent separation of fitting 901 from rail 900, an insert 916 is provided that, when portion 902 is moved into its operating position (as shown in FIG. 40) can be pushed in the direction of arrow 918 (FIG. 41) into a cooperating opening 917 in portion 902. Insert 916 has surfaces 919 that are parts of a sphere and are of similar radius of curvature to surface 904 of portion 902 to permit rotation of fitting 901 and insert 916 about axis 905 (although retarded by the detent means mentioned above and optionally a further means mentioned below). In the position shown in the Figures, insert 916 protrudes far enough from portion 902 that the combination of fitting 901 and insert 916 is captive in railing 900.

Conveniently, insert 916 may be (and in the Figures is) tied on a cord 920 that in turn is secured to pin 913. However, other suitable arrangement will readily suggest themselves to persons skilled in the art. Insert 916 may taper slightly along its length so that it lodges in a wedging fashion in portion 902.

Insert 916 may be made in such a way as to limit any tendency of an upright of which fitting 901 is a part to rotate continuously about axis 905 after carrying away at its lower end under impact. This can be done in several ways. Insert 916 may be a slightly tighter fit in cavity 903 than portion 902 and/or may be made from a substance chosen to provide a degree of braking effect, through frictional contact with cavity 903. For example, insert 916 could comprise a hard rubber or similar somewhat elastomeric material, or a mixture of such a material with a plastics material. A particular way to make insert 916 a tighter fit in cavity 903 than portion 902, is to make it slightly longer than would be required to make the combination of portion 902 and insert 916 freely rotatable in cavity 903. Then, when the curved surfaces 919 come into contact with inward facing surfaces of cavity 903, they are pressed hard enough against such surfaces for friction to slow the rotation down.

Although various combinations of upper-end and lower-end arrangements are intended to be possible, it may assist understanding to describe assembly of an upright to a rail assembly for a particular combination that has been found to work well. This is an upright 965 having a smoothly bent tube 964 with a fitting 901 (FIGS. 40-42) at its upper end for securing to a rail such as rail 900 and a fitting 956 at its lower end for attachment to a ground anchor 951. A user would first position upright 965 in a horizontal plane at rail height and enter portion 902 of fitting 901 into cavity 903 of rail 900. Then upright 965 would be rotated downward about axis 905 to lower end fitting 956 where it could be positioned on ground anchor 951. Plate 955 would be rotated suitably about axis 963 so that pin 958 could enter recess 960 easily, and rotation of upright 965 about axis 905 continued until plate 955 reaches its operating position (as shown in FIG. 37) on ground anchor 951, plate 955 rotating about pin 958 during receipt of fitting 956 on ground anchor 951. Finally, insert 916 would be positioned in portion 902 of fitting 901.

### (cc) Further Rail Joining Arrangements

There will now be described a further means and method for joining rail lengths 2000 to form a rail assembly such as rail assembly 2. Refer to FIG. 50, which shows in an exploded view parts of two adjoining rail lengths 2000a and 2000b to be joined end to end. FIG. 51 is a cross-sectional view on a plane extending lengthwise of the joined rail lengths 2000a and 2000b.

FIG. 50 shows two interlocking parts 2002 and 2004. Body 2002 can be entered slideably into a space 2051 (see FIG. 51) in a left hand end of rail length 2000b and then prevented from longitudinal sliding by bolt 2008 which slides in slot 2010 and can be received in a threaded hole 2012 of body 2002. Similarly, body 2004 can be entered into the corresponding space 20121 at a right hand end of a rail length 2000a (as shown by arrow 2014) and either slid lengthwise in space 20121 or secured against sliding by a bolt 2016 that passes through a slot 2018 and into threaded hole 2020 in body 2004. Body 2004 has a boss 2022 that can be close fittingly received in a hole 2024 in body 2002 to prevent longitudinal relative movement of the bodies 2002 and 2004.

When the two bodies 2002 and 2004 are thus connected, and provided body 2004 is kept fully withdrawn into space 20121 of rail length 2000a, the two rail lengths are held together and in alignment both vertically and laterally of the rail lengths 2000a and 2000b. If both bolts 2008 and 2016 are tightened, the lengths 2000a and 2000b are actually joined longitudinally as well, as may be desirable during fence erection and relocation procedures. However, if one is loosened, some relative longitudinal movement of the two lengths 2000a and 2000b can take place, allowing takeup of thermal expansion during barrier use. Slots 2018 and 2010 are chosen so that body 2004 can be kept wholly inside space 20121 after joining to body 2002, but pulled out far enough for initial joining to body 2002. A gap 2053 is shown in FIG. 51 that if bolt 2008 is tight, for example, permits rail length 2000b to expand thermally towards length 2000a, shortening gap 2053 and pushing body 2004 further into space 20121.

It is undesirable to have the actual extrusion end corners 2026 and 2028, and gap 2053 left exposed, because of possible injury to horses (for example) and riders if they impact the barrier of which lengths 2000a and 2000b are a part. Therefore a sleeve 2030 is provided as part of the joining arrangement and method.

Sleeve 2030 is elongate and shaped to conform closely and snugly to the outside surface of rail length 2000b. It may be made (for example only) by injection moulding in a suitable plastics material and in such a way that placing it over rail length 2000b requires a small degree of outward flexing or springing of the sleeve 2030, and it is held snugly in place. Sleeve 2030 is generally C-shaped in cross-section for the particular rail length extrusions 2000a/b shown, not covering their entire circumference. (This aids in preventing springing.) At one end of sleeve 2030 there are provided fingers 2032a-2032g that extend longitudinally of the remainder of the sleeve 2030 and the rail extrusion 2000b and that in the completed rail joint are snugly received into internal spaces 2034a-2034g of the rail length 2000a, in such a way that they bear on the inner surfaces of the outer wall portion 2036a of rail length extrusion 2000a as shown in FIG. 51. Sleeve 2030 can be secured in place to rail length 2000a by for example adhesive or (if applicable to the plastics material used) solvent cement.

FIG. 51 is a longitudinal cross-sectional view of the completed joint showing how sleeve 2030 is rounded at end locations 2038 and 2040 around the periphery of sleeve 2030, to limit the chance of impact injury, and how a shoulder 2042 is provided against which an end edge 2026 of rail length 2000a can rest. Wall 2036b of rail length 2000b is slidingly received against the inside surface 2046 of sleeve 2030.

If there is a preferred (or usually used) racing direction, arrow 2044 shows the preferred way in which it should be oriented relative to sleeve 2030.

Bodies 2002 and 2004 may be injection molded in a suitable plastics material (although there is no intention that only such materials or construction can be used), and the threaded holes 2012 and 2020 may be provided by making metal (eg steel) nuts (not shown) captive in the bodies 2002 and 2004.

Once sleeve 2030 is secured in pace on rail length 2000a, body 2004 is slid out of space 20121 enough to expose its end part with boss 2022. Rail length 2000b is then “snapped” laterally into the position in sleeve 2030 shown in FIG. 51, with body 2002 partly protruding from space 2051 so that boss 2022 enters hole 2024. The bodies 2002 and 2004 are then slid into the positions shown in FIG. 51 and one of the bolts 2008 and 2016 fully tightenend, the other being left with enough play for sliding as described above. This completes the joining of rail lengths 2000a and 2000b.

Alternatively body 2002, separated from rail length 2000b and bolt 2008, can be secured to body 2004 and body 2004 slid into the position of FIG. 51, leaving body 2002 protruding lengthwise. Rail length 2000b is then advanced longitudinally towards length 2000a so body 2002 enters space 2051, and bolt 2008 entered into hole 2012, and tightened.

### (dd) Barrier Fence Erection Methods

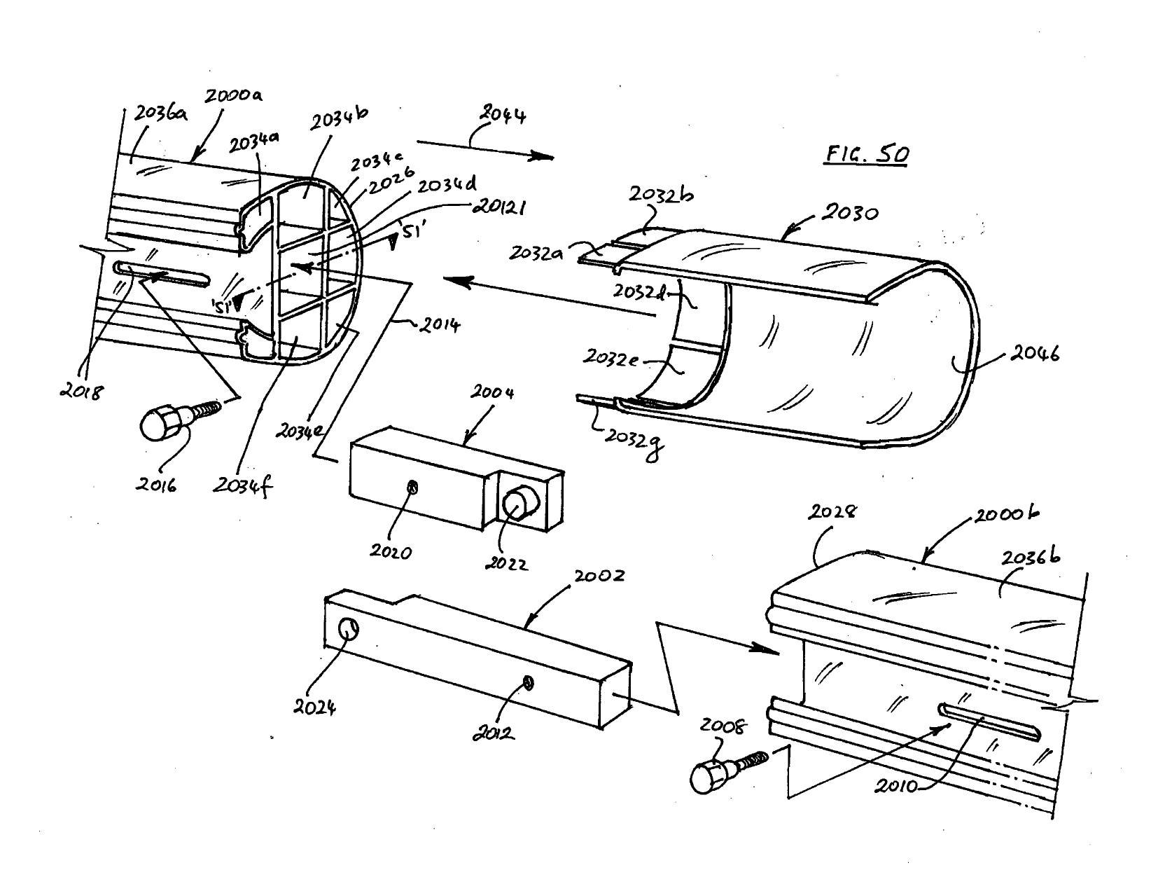

There will now be described convenient ways of erecting and disassembling and moving barrier fences according to the invention by reference to a barrier fence portion 1007 shown in FIG. 47.

FIG. 45 shows in perspective view a ground anchor assembly 1004 that is similar to ground anchor assembly 201 of fence 218, except in two respects. One respect is that the pin 215 and plate 214 of ground anchor 201 are replaced by a component 1050 that is not integral with plate 1006 of ground anchor 1004 (equivalent to plate 204 of ground anchor 201) but connectable thereto. Component 1050 is not relevant to this discussion of erection, disassembly and shifting methods.

The second difference between ground anchor 1004 and ground anchor 201 is relevant to barrier erection and relocation and lies in the presence of two openings 1052 and 1054 in plate 1006. Openings 1052 and 1054 are shown as part-circular notches, but can if required be actual holes (not shown) through plate 1006.

FIG. 47 shows barrier fence portion 1007 comprising a rail assembly 1011, an upright assembly 1009, with an upper end fitting 1013 and lower end fitting 1005 and ground anchor 1004. A powered mechanical hammer 1058 (eg of electrical, hydraulic or pneumatic type) is shown, and is fitted with a special fitting 1060 that can be used to drive ground anchor 1004 downward into the ground. Fitting 1060 is shown in FIG. 48. In FIG. 47, not only ground anchor 1004 is shown, but also upright assembly 1009 connected to anchor 1004 and part of a rail assembly 1011. It is actually possible to use the driving method shown in FIG. 47 to drive only a ground anchor 1004 into the ground, or to secure to the ground the ground anchor 1004 with upright assembly 1009 (only) connected thereto, or even to drive a portion of a fence assembly comprising rail assembly 1011, upright assemblies 1009 and ground anchors 1004, as shown.

Fitting 1060 has a shaft 1062 that in us extends upwards, for fitment to the hammer 1058 and a plate 1064 supporting two parallel and downwardly depending prongs 1066 and 1068. Prongs 1066 and 1068 in use are entered into and lodge in openings 1054 and 1052 respectively. Bosses 1070 and 1072 transmit impact forces from hammer 1058 to plate 1006 during driving, and they and plate 1064 are shaped and proportioned so that the thrust delivered by hammer 1058 to ground anchor 1004 is so directed (along a line approximately parallel to and close to the lower portion of upright assembly 1009) as to effectively drive anchor 1004 into the ground, without significant tendency to tilt out of the vertical. To drive anchor 1004 into the ground, an operator simply inserts prongs 1066 and 1068 into openings 1054 and 1052, with bosses 1070 and 1072 abutting the plate 1006, and drives the fitting 1060, and with it the anchor 1004, into the ground. When the anchor 1004 is fully home (with plate 1006 substantially at ground level) the prongs 1066 and 1068 (which are not a tight fit in openings 1054 and 1052) are readily withdrawn upward and the process of placement of anchor 1004 is complete.

Further, fitting 1060 is so shaped and proportioned that if it is used to drive an anchor 1004 into the ground already fitted with an upright assembly 1009, the upright assembly is necessarily correctly located on ground anchor 1004. This can be done (for example only) by providing that lower end fitting 1005 is received neatly between bosses 1070 and 1072 only when it is correctly positioned on plate 1006.

Using these components, there are several ways to erect a barrier fence of the type of which a portion is shown in FIG. 47.

In one method, a row of ground anchors 1004, ready fitted with upright assemblies 1009 complete except for their upper end fittings 1013 are secured in the ground as described above. Then, a chosen length of rail assembly 1011 prefitted with upper end fittings 1013 is lifted and positioned so that the end fittings 1013 can be entered into and secured by pinning or other means to the upper ends of those parts of the upright assemblies 1009 secured to the ground anchors 1004. This completes the barrier.

Alternatively, the ground anchors 1004 only may be driven into the ground, and the uprights 1009 and rail assembly 1011 fitted subsequently.

Still another possibility is to assemble complete fence portions 1007, being rail assembly 1011, uprights 1009 and ground anchors 1004, lift the assembly into the required position and use the driving method described above to secure each of the anchors 1004 into the round.

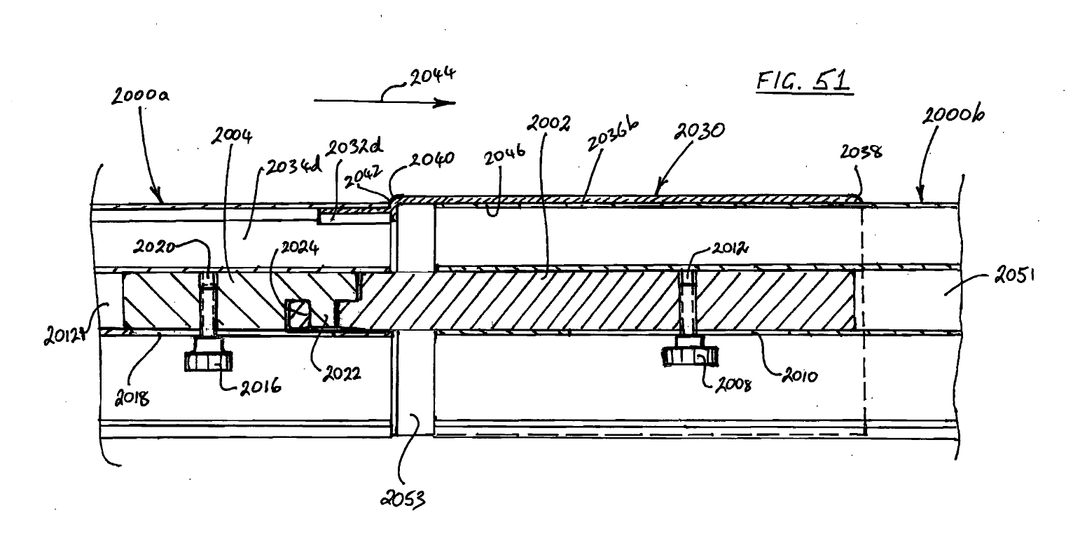

Ground anchors 1004, or ground anchor/upright combinations, or complete assembled fence portions 1007 can be easily removed from a given position and relocated as follows. FIG. 49 shows a simple lever 3000 having two coaxial wheels 3002 (one is visible) acting as a movable fulcrum. One end 3004 of lever 3000 acts as a handle and the other end 3006 is fitted with a pronged fitting 3008 essentially the same as fitting 1060 except that it has no shaft 1062, fitting 3008 being at the end of a short length of chain 3010. Chain 3010 is offset longitudinally of lever 3000 from prongs 3012. Prongs 3012 are placed into openings 1054 and 1052, and handle end 3004 is pushed down. Because chain 3010 is offset from the prongs 3012 toward the wheels 3002, prongs 3012 simply jam in openings 1052 and 1054 rather than being pulled out. The anchor 1004 (and anything attached to it if applicable) is simply lifted from the ground, and can be shifted to an desired new location. Once the anchor 1004 is clear of the ground, it normally drops off prongs 3012.

Using the equipment described above, barrier fences can be erected, relocated and removed as required.

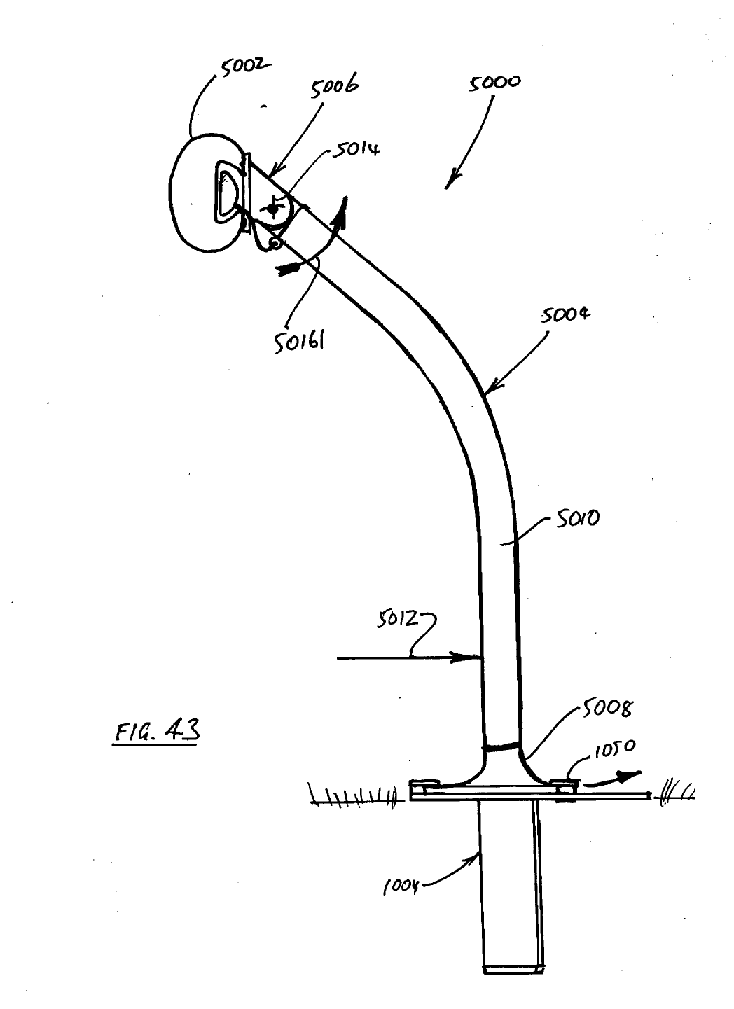

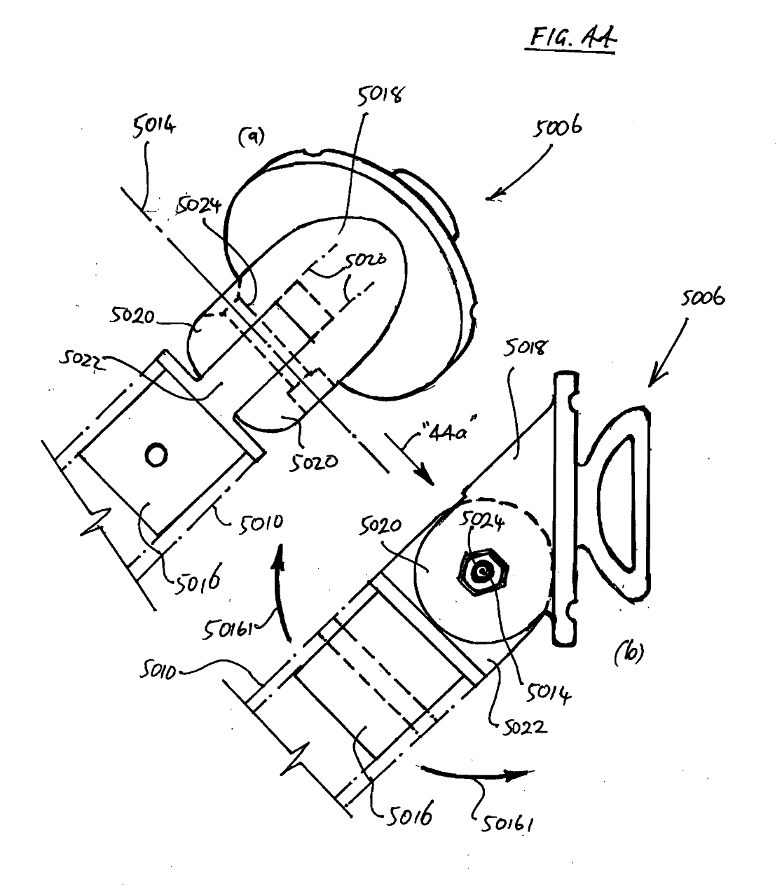

There will now be described further possible variations to barrier fences according to the invention. FIG. 43 shows a view along a barrier fence 5000 comprising a rail assembly 5002 and uprights 5004 spaced apart and secured to rail assembly 5002. Upright 5004 has an upper end fitting 5006, a lower end fitting 5008 and between them a tubular portion 5010. Upright 5004 is mounted to a ground anchor 1004 shown in FIG. 45.

Ground anchor 1004 is generally similar to ground anchor 201 as mentioned above, except for openings 1052 and 1054 and for the use of component 1050 in place of pin 215 and plate 214. Component 1050 holds down one end of bottom end fitting 5008 and acts as a shear pin in response to loads applied in approximately the direction range shown at 224 in FIG. 28. The purpose is to allow lower end fitting 5008 to separate from ground anchor 1004 in response to sufficiently high impact loads applied to the uprights in the angle range mentioned. That is, component 1050 acts like the shear pin 229 and plate 231 of ground anchor 227 described above. Although there are many possible forms component 1050 may take (see also FIG. 30), it is shown in FIG. 46 as being of generally square section and received in a punched square hole 5050 in plate 1006, and having a frangible notch 5052 extending peripherally around a body 5056 just above plate 1006. A cotter pin 5054 is shown retaining body 5056 in place and a formation 5058 abuts plate 1006 to prevent body 5056 falling down through hole 5050. An integral plate 5060 holds lower end fitting 5008 against plate 1006. Front surface 5062 of component 1050 may be shaped to provide for lower end fitting to be snap fittingly received on ground anchor 1004 or alternatively just slid into place, without snap-fitting, as described above.

FIG. 45 shows the outline 5070 of a lower end fitting 5008 in chain-dotted lines on plate 1006. Lower end fittings may be altered to have a different such outline to cooperate with a fitting 1060 described below. Another possibility is to alter the outline for example as shown by line 5072 so as to cause failure of component 1050 not only under substantially lateral loads but under loads with larger longitudinal components.

Of course, ground anchor 1004 also allows the lower end fitting 5008 to separate under loads in the angle ranges 225 and 226 of FIG. 28 under loads suitably directed and in the way described above in the description of ground anchor 201.

Formation 5064 of ground anchor 1004, shown in FIG. 45, serves the same function as pin 211 and plate 212 of ground anchor 201. Like component 1050, formation 5064 may itself be a component designed to be separable from plate 1006, in the same way as component 1050.

(ee) Provision for Rotation of Upright about an Additional Axis after Carrying Away of Lower End

If a lateral and generally rearwardly directed load such as is represented by arrow 5012 in FIG. 43 does cause lower end fitting 5008 to separate from ground anchor 1004, it is desirable that there not be too much resistance thereafter to movement of the upright 5004. If load 012 is purely lateral the ability of the various top end fittings described earlier to allow rotation of uprights about a lateral horizontal axis may not be adequate. Accordingly, top end fitting 5006 also allows rotation, if lower end fitting 5008 separates from ground anchor 1004, of upright 5004 about a horizontal and longitudinal axis 5014, as shown by arrows 50161.

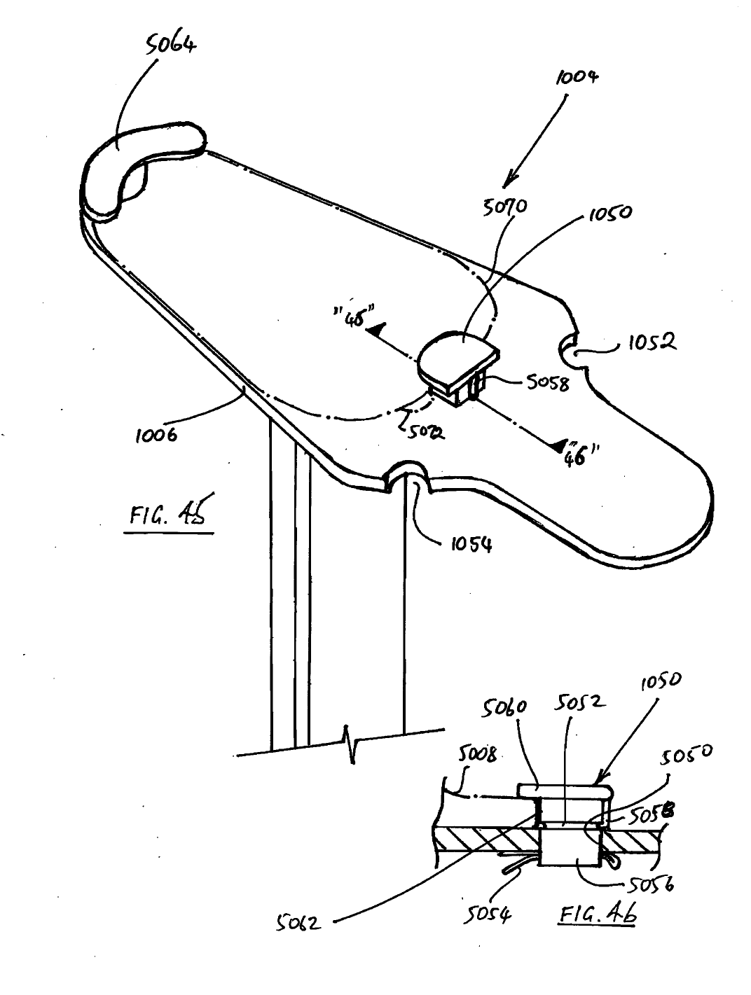

Referring to FIG. 44, top end fitting 5006 connects to rail assembly 5002 in just the same way as fitting 901 connects to rail assembly 900. Refer to the description above for description of this. However, fitting 5006 has a stub 5016 that is received in the tubular upright part 5010 but is hinged to a formation 5018 so as to allow rotation of stub 5010 about the axis 5014. To this end, formation 5018 is bifurcated into two tangs 5020 that lie on opposite sides of a tang 5022 extending from stub 5016 and a pin 5024 permitting the rotation passes through tangs 5020 and 5022.

To ensure that rail assembly is always correctly oriented, it is necessary that stub 5016 not be freely rotating about axis 5014 in formation 5018. Pin 5024 may comprise a nut and bolt, tightened to a controlled degree (i.e. torqued) to achieve this. Alternately tangs 5020 and 5022 may be made with cooperating formations (not shown) on their planes of contact 5026 that resist relative rotation to a controlled degree. Another possibility is to use a shear pin between tangs 5020 and 5022.

Instead of the comparatively complex upper end fitting 5006, another possibility is to use a simpler fitting such as fitting 901 and to rely on suitable choice of the torsional stiffness of the rail assembly 5002. This depends on (a) the longitudinal upright spacing, the section characteristics of the rail extrusions, and the material used for the rail extrusions. Then, when lower end fitting 5008 separates from ground anchor 1004 under a generally laterally applied impact, the rail assembly 5002 twists allowing upright 5004 to rotate in a similar way to the rotation of upright 5004 about axis 5014 in FIG. 43.

### (ff) Provision for Preferred Barrier Fence Positions

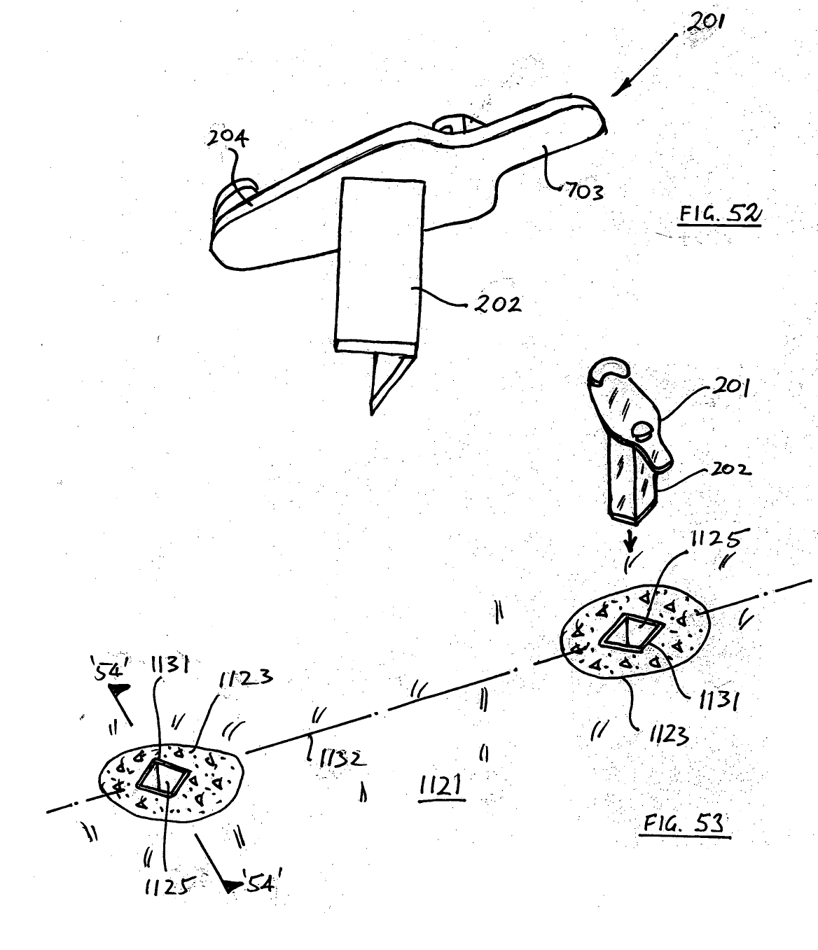

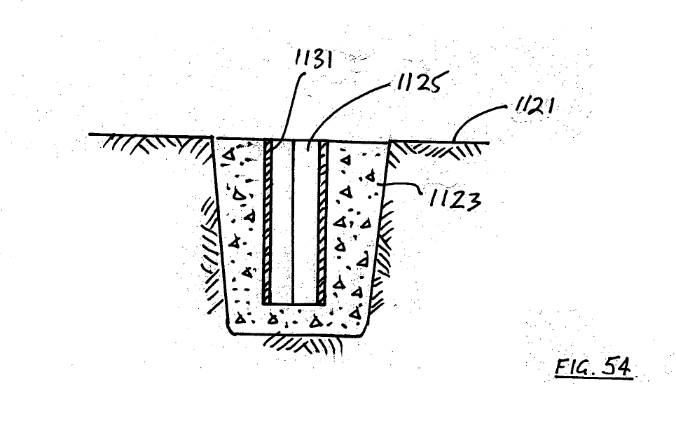

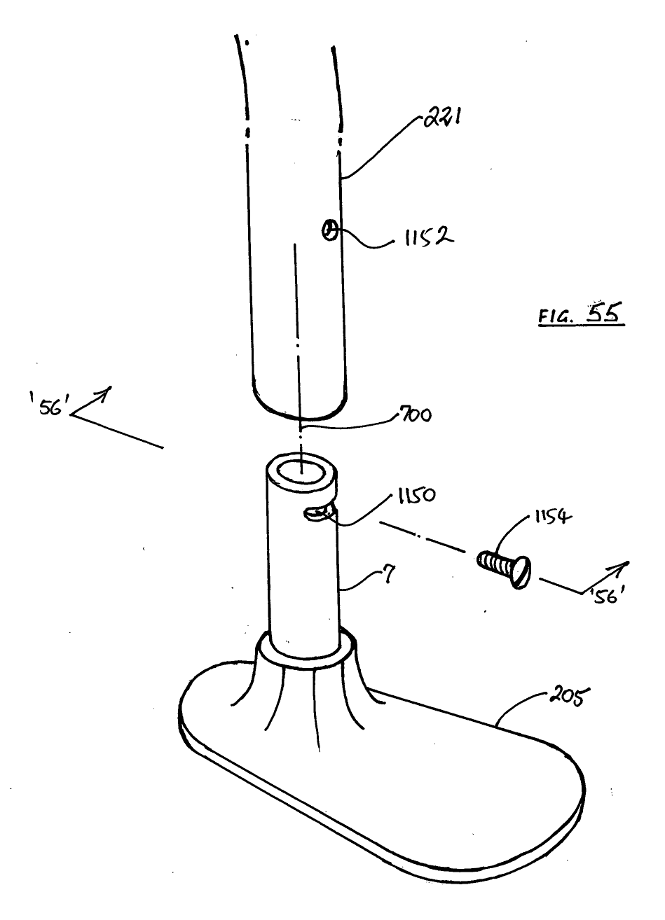

It may be the case, and at race tracks often is, that there is a normal, standard or preferred position for a barrier fence such as, for example, barrier fence 218 where it will often be used, with other positions being used less often. It is desirable therefore that the fence be especially easy and quick to erect in (or remove from) that preferred position. It is further desirable to avoid the ground damage that can accompany repeated driving in of their ground anchors, such as the ground anchors 201 of fence 218. A way to address this issue is described now, by reference to FIGS. 52, 53 and 54. For convenience, the description will be made for fence 218, although note that fence 218 can also be used without the ground surface modifications described below.

It is important to the correct functioning of fence 218 when it is subject to impact that ground anchors 201 be correctly oriented relative to the rail assembly 219. When ground anchors 201 are being driven into a ground mass 1121, it is therefore necessary to use care in the positioning of footings 201.

Referring to FIG. 53, there is shown a ground surface 1121, provided with a row of concrete footings 1123 let into the surface 1121. Each footing 1123 has a hole 1125 so shaped sized and oriented that the lower section (spike portion) 202 of a ground anchor 201 can be received therein, and be held in a correct orientation for the fence 218. Line 1132 represents a line along which the footings 201 are to be arrayed in a preferred position of fence 218.

Hole 1125 can optionally (but preferably) be defined by provision of a tube 1131 in footing 1123. A square tube 1131 can suit the spike shape shown on ground anchor 201. More generally, the hole 1125 in a footing 1123 provided according to this aspect of the invention can be any shape suitable for holding a depending part of a footing in its correct orientation.

Although not shown, a simple cap (eg of plastics material) may be provided for each footing to close hole 1125 when the footing is not in use.

Erection of fence 218 in its preferred position is simplified by the fact that ground anchors 201 can simply be dropped into place in each footing 1123 and the uprights 220 attached to them. When the fence 218 is to be moved to another position, the ground anchors 201 can be lifted out of holes 1125, and either driven into the ground as spikes (if footings like footings 1123 are not available in the new position) or dropped into similar footings 1123 in the new position if these are available.

### (gg) Connection of Upright Tube to Bottom End Footing

As stated above, it is desirable that the tube portion of an upright be able to rotate relative to the upright's bottom end fitting about an upright axis. Thus, using barrier fence 218 purely as an example, tube 221, should be able to rotate relative to stub 207 of bottom fitting 205 about an upright axis 700 (see FIG. 25). A simple way of achieving this is shown in FIGS. 55-57.

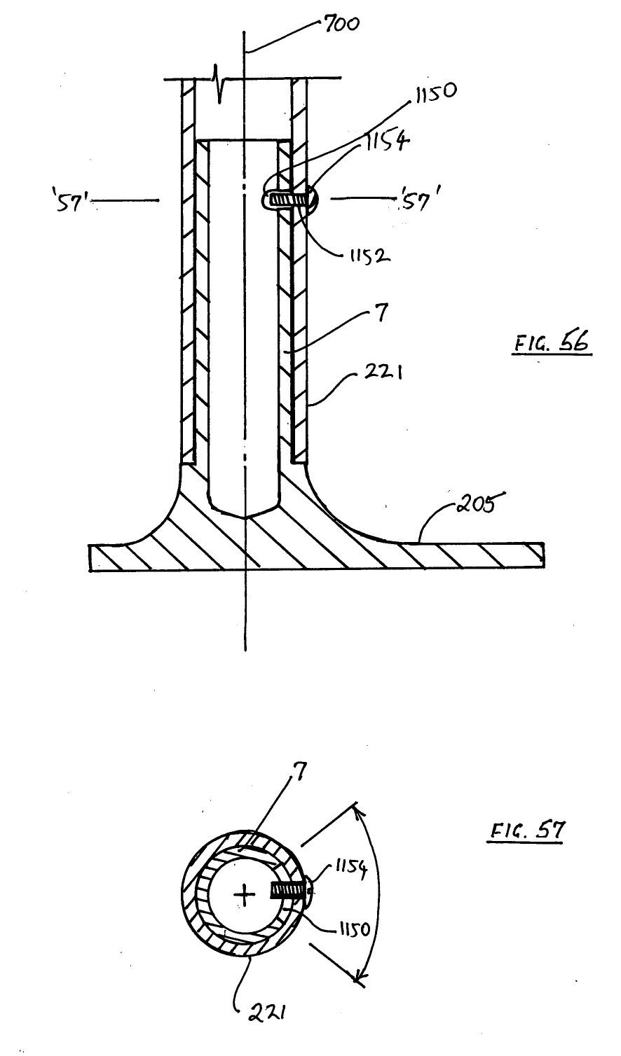

Stub 207 is provided with a slot 1150 extending partway around its periphery, and tube 221 has a hole 1152 in which is received a screw 1154, hole 1152 and slot 1150 being in registration (see FIG. 56) so that screw 1154 extends through slot 1150. Hole 1152 may be threaded to mate with screw 1154 or screw 1154 may be a self-tapping screw. Because screw 1154 passes through slot 1150, relative rotation of stub 207 and tube 221 about axis 700 is possible, but tube 221 and stub 207 are kept together. Keeping tube 221 and stub 207 together after foot 205 has separated from ground anchor 201 is important to reduce the risk of injury to persons nearby. If foot 205 is an injection molded plastics component, provision of slot 1150 is not difficult to achieve in the course of molding, or it may be cut after molding.

Equivalently (but not shown), there may be a peripheral slot in tube 221 with a screw (or similar elongate component) secured to stub 207 and extending through the slot in tube 221.

Provision of slot 1150 is an alternative to provision of a groove in stub 207 and allows a smaller wall thickness for stub 207 than if a groove is used as described earlier.

Barrier fences according to the invention may be constructed using any suitable materials. The following are non-limiting examples. For rails (eg 2, 219, 900), extrusions in plastics such as PVC have been found suitable. For tubing to be used in uprights (eg tubes 12, 221), PVC (especially) and polycarbonate plastics have been found suitable. For uprights' upper and lower end fittings and rail joining components, plastics materials such as HDPE have been found suitable. Steel has been found suitable for ground anchors.

Yet more variations, additional to those described above, may be made that do not exceed the scope of the present invention. It will be recognized that a very large number of configurations, components and features have been described that may be chosen from to produce barrier fences that respond predictably to a range of impact loadings. Persons skilled in the art will readily be able to select from among the various configurations, components and features to obtain a barrier fence suitable for a given purpose.

1. A barrier fence comprising an elongate rail and uprights secured thereto at positions along the rail, wherein an upright is secured at an upper end to the rail and at a lower end to a ground anchor and wherein the lower end of the upright is adapted to separate from its associated ground anchor in response to an impact load on the upright and characterized in at least one of the followings ways:
(a) prevention of separation of the upright from the ground anchor is achieved substantially by means of contact pressure between a lower end fitting comprised in the upright and formations comprised in the ground anchor as opposed to mechanical confinement of the lower end fitting by the ground anchor when the lower end fitting is secured to the ground anchor;
(b) a lower end fitting comprised in the upright is non-snap-fittingly secured to the ground anchor;
(c) a lower end fitting comprised in the upright is in use located on the ground anchor by a frangible means connecting the lower end fitting and the ground anchor the frangible means preferably comprising a shear pin and said frangible means contributing only a minority of resistance to separation of the lower end fitting from the ground anchor;
(d) an upper end fitting comprised in the upright is held captively secured to the rail for a defined range of relative positions of the upper end fitting only and the upper end fitting is provided with removable means for preventing separation of the upper end fitting and the rail when the upper end fitting is outside the defined range;
(e) the rail and an upper end fitting comprised in the upright are so configured as to provide a detent against and/or frictional resistance to relative movement of the upper end fitting and the rail in at least one relative position of the upper end fitting and the rail in which the upright is separated from the ground anchor;
(f) an upper end fitting comprised in the upright is adapted to permit rotation of the upright about multiple axes after separation of a lower end fitting comprised in the upright from the ground anchor;
(g) the ground anchor has a portion that is adapted to be either driven into a ground surface or received in a shaped opening in a ground surface and held against rotation about an upright axis when in said shaped opening;
(h) firstly, the upright comprises a tube and a lower end fitting that is received and rotatable in a lower end of the tube and secondly one of the lower end fitting and the tube is provided with a slot extending partway peripherally around that one and thirdly to the other of the lower end fitting and the tube there is secured an elongate means (preferably a screw) receivable in the slot so as to secure the lower end fitting to the tube and so as to permit relative rotation of the tube and the lower end about a mutual longitudinal axis within a range defined by the length of the slot;
(i) the rail comprises a plurality of rail lengths joined end to end and comprises at a joint between two such rail lengths a sleeve that extends at least partway around an external surface of one of the lengths and that comprises one or more formations that are received in internal spaces of the other of the lengths; and
(j) the rail comprises a plurality of rail lengths joined end to end and comprises at a joint between two such rail lengths two elongate bolt members each one slidingly received in an internal space of one of the rail lengths, the bolt members having formations that cooperate with each other so as to prevent longitudinal relative movement of the bolt members;

2. A barrier fence comprising an elongate rail and uprights secured thereto at positions along the rail, wherein the rail comprises a plurality of rail lengths joined end to end and comprises at a joint between two such rail lengths a sleeve that extends at least partway around an external surface of one of the lengths and that comprises one or more formations that are received in internal spaces of the other of the lengths.

3. A method for erecting a barrier fence comprising an elongate rail and uprights secured thereto at positions along the rail, and wherein an upright is secured at an upper end to the rail and at a lower end to a ground anchor the method including the step of driving a ground anchor into a ground surface using hammer means adapted to bear on the ground anchor.

4. A method according to claim 3 wherein the said step is carried out with an upright secured to the ground anchor.

5. A method for dismantling a barrier fence comprising an elongate rail and uprights secured thereto at positions along the rail, and wherein an upright is secured at an upper end to the rail and at a lower end to a ground anchor the method including the step of withdrawing a ground anchor from a driven-in position in a ground surface using lever means adapted to raise a fitting that in use grips the ground anchor.

6. A method according to claim 5 wherein the said step is carried out with an upright secured to the ground anchor.

7. A barrier fence comprising an elongate rail and uprights secured thereto at positions along the rail, wherein an upright is secured at an upper end to the rail and at a lower end to a ground anchor and wherein the ground anchor is received in a shaped opening in a ground surface and said ground anchor and said opening being sized and shaped such that said ground anchor is prevented from rotation about an upright axis when in said shaped opening.

8. A barrier fence comprising an elongate rail and uprights secured thereto at positions along the rail, wherein an upright is secured at an upper end to the rail and at a lower end to a ground anchor.

9. A barrier fence according to claim 8 wherein the lower end of the upright is adapted to separate from its associated ground anchor in response to an impact load on the upright, and characterized in that prevention of separation of the upright from the ground anchor is achieved substantially by means of contact pressure between a lower end fitting comprised in the upright and formations comprised in the ground anchor as opposed to mechanical confinement of the lower end fitting by the ground anchor when the lower end fitting is secured to the ground anchor;

10. A barrier fence according to claim 8 wherein the lower end of the upright is adapted to separate from its associated ground anchor in response to an impact load on the upright, and characterized in that a lower end fitting comprised in the upright is non-snap-fittingly secured to the ground anchor.

11. A barrier fence according to claim 8, wherein the lower end of the upright is adapted to separate from its associated ground anchor in response to an impact load on the upright, and characterized in that a lower end fitting comprised in the upright is in use located on the ground anchor by a frangible means connecting the lower end fitting and the ground anchor the frangible means preferably comprising a shear pin and said frangible means contributing only a minority of resistance to separation of the lower end fitting from the ground anchor.

12. A barrier fence according to claim 8 wherein the lower end of the upright is adapted to separate from its associated ground anchor in response to an impact load on the upright, and characterized in that an upper end fitting comprised in the upright is held captively secured to the rail for a defined range of relative positions of the upper end fitting only and the upper end fitting is provided with removable means for preventing separation of the upper end fitting and the rail when the upper end fitting is outside the defined range.

13. A barrier fence according to claim 8, wherein the lower end of the upright is adapted to separate from its associated ground anchor in response to an impact load on the upright, and characterized in that the rail and an upper end fitting comprised in the upright are so configured as to provide a detent against and/or frictional resistance to relative movement of the upper end fitting and the rail in at least one relative position of the upper end fitting and the rail in which the upright is separated from the ground anchor.

14. A barrier fence according to claim 8 wherein the lower end of the upright is adapted to separate from its associated ground anchor in response to an impact load on the upright, and characterized in that an upper end fitting comprised in the upright is adapted to permit rotation of the upright about multiple axes after separation of a lower end fitting comprised in the upright from the ground anchor.

15. A barrier fence according to claim 8 wherein the lower end of the upright is adapted to separate from its associated ground anchor in response to an impact load on the upright, and characterized in that the ground anchor has a portion that is adapted to be either driven into a ground surface or received in a shaped opening in a ground surface and held against rotation about an upright axis when in said shaped opening.

16. A barrier fence according to claim 8 wherein the lower end of the upright is adapted to separate from its associated ground anchor in response to an impact load on the upright, and characterized in that firstly, the upright comprises a tube and a lower end fitting that is received and rotatable in a lower end of the tube and secondly one of the lower end fitting and the tube is provided with a slot extending partway peripherally around that one and thirdly to the other of the lower end fitting and the tube there is secured an elongate means (preferably a screw) receivable in the slot so as to secure the lower end fitting to the tube and so as to permit relative rotation of the tube and the lower end about a mutual longitudinal axis within a range defined by the length of the slot.
